(19) United States
(12) Patent Application Publication
(10) Pub. No.: US 2007/0018917 A1
(43) Pub. Date: Jan. 25, 2007

(54) Electronic device, method of driving the same, electro-optical device, and electronic apparatus

(75) Inventor: Takashi Miyazawa, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/456,963

(22) Filed: Jul. 12, 2006

(30) Foreign Application Priority Data
Jul. 15, 2005 (JP) 2005-206559
Jul. 25, 2005 (JP) 2005-213803

(51) Int. Cl. G09G 3/30

(52) U.S. Cl. 345/76

(57) ABSTRACT

A method of driving an electronic device, which has a driving transistor having a control terminal a first terminal, and a second terminal, a conduction state between the first terminal and the second terminal changing according to a potential of the control terminal, and a unit circuit having a driven element to be driven according to the conduction state of the driving transistor, includes supplying a first potential to a potential supply line in an initialization period, and electrically connecting the potential supply line and the control terminal of the driving transistor to each other, electrically connecting a data line to which a data signal is supplied, and the first terminal of the driving transistor to each other in a writing period after the initialization period, and supplying a second potential different from the first potential to the potential supply line in a driving period after the writing period, and electrically connecting the potential supply line and the second terminal of the driving transistor in the driving period so as to drive the driven element.

### BACKGROUND

1. Technical Field

The present invention relates to a technique for controlling behaviors of various driven elements, such as organic light-emitting diode (hereinafter, referred to as ‘OLED’) elements, liquid crystal elements, electrophoretic elements, electrochromic elements, electron emission elements, resistive elements.

2. Related Art

Various electronic devices, such as electro-optical devices (light-emitting device) using OLED elements include a plurality of unit circuits that are arranged in a planar manner. Each of the unit circuits has, for example, a transistor (hereinafter, referred to as ‘driving transistor’) whose gate is set to a potential according to a data signal, and a driven element (for example, an OLED element) that is driven by a current flowing in the driving transistor according to the potential of the gate (for example, see '51.4: Invited Paper: Modeling and Design of Polysilicon Drive Circuits for OLED Displays', Simon W.-B. Tam, Tatsuya Shimoda, SID 04 Digest, pp. 1406 to pp. 1409 (hereinafter, referred to as ‘Non-Patent Document 1′). In addition, a configuration in which a transistor (hereinafter, referred to as ‘driving control transistor’) Tr0 is interposed between a driving transistor Tdr and a driven element 11, as shown in FIG. 22, has been suggested (for example, see Non-Patent Document 1). According to this configuration, a period where the driven element 11 is actually driven (for example, a period where a current is supplied to the driven element 11) can be accurately defined by the control of the driving control transistor Tr0.

Meanwhile, in order to rapidly control a potential of a gate of the driving transistor with high accuracy, before the supply of the data signal, the gate of the driving transistor is preferably initialized to a predetermined potential (hereinafter, referred to as ‘initialization potential’) that does not have relation to the data signal. In order to realize the initialization, for example, a wiring line that supplies the initialization potential to each unit circuit needs to be formed over the plurality of unit circuits, and a switching element that switches conduction and non-conduction between the wiring line and the gate of the driving transistor needs to be provided in each unit circuit. However, according to this configuration, due to the addition of the wiring lines or switching elements, the configuration of each unit circuit is complicated, and an aperture ratio is decreased.

In the above-described configuration, in addition to the driving transistor Tdr, the driving control transistor Tr0 needs to be formed in each of the plurality of unit circuits and a wiring line that controls the driving control transistor Tr0 needs to be formed in each of the plurality of unit circuits. Accordingly, there is problem in that the configuration of the unit circuit is complicated, or an aperture ratio is decreased.

### SUMMARY

An advantage of some aspects of the invention is that it realizes initialization of a gate of a driving transistor, without complicating the configuration of each unit circuit

Another advantage of some aspects of the invention is that it controls a driving period of a driven element, without complicating the configuration of each unit circuit.

According to a first aspect of the invention, an electronic device includes a plurality of first wiring lines (for example, scanning lines 12 of FIG. 1, and in particular, first control lines 121 of FIG. 2), a plurality of second wiring lines (for example, data lines 14 of FIG. 1) that intersect the plurality of first wiring lines, a plurality of potential supply lines, a plurality of unit circuits that are correspondingly disposed at intersections of the plurality of first wiring lines and the plurality of second wiring lines, a selection circuit (for example, a scanning line driving circuit 22 of FIG. 1) that selects each of the plurality of first wiring lines, a data supply circuit (for example, a data line driving circuit 24 of FIG. 1) that supplies a data signal to each of the plurality of second wiring lines in each writing period, and a voltage control circuit that sets each of the plurality of potential supply lines to have a plurality of potentials. Each of the plurality of unit circuits has a driving transistor that has a control terminal (gate), a first terminal (one of a source and a drain), and a second terminal (the other of the source and the drain), a conduction state between the first terminal and the second terminal changing according to a potential of the control terminal, a driven element that is driven according to the conduction state of the driving transistor, a first switching element (for example, a transistor Tr1 of FIG. 2) that electrically connects the first terminal of the driving transistor and the second wiring lines to each other in a writing period where a first wiring line corresponding to the unit circuit is selected, and a potential setting unit (for example, a transistor Tr2 and a transistor Tr3 FIG. 2) that electrically connects the corresponding potential supply line and the control terminal of the driving transistor to each other in an initialization period before the start of the writing period, and electrically connects the corresponding potential supply line and the second terminal of the driving transistor to each other in a driving period after the writing period. More specifically, the voltage control circuit supplies a first potential (a first potential Vss in a first embodiment) to one potential supply line in the initialization period, and supplies a second potential (a second potential Vdd in a first embodiment) different from the first potential to one potential supply line in the driving period.

According to this configuration, the potential supply line that supplies the second potential to the second terminal of the driving transistor in the driving period, is also used as a wiring line that supplies the first potential to the control terminal of the driving transistor in the initialization period. Therefore, the configuration of each unit circuit can be simplified, as compared with the configuration in which the part for initializing the potential of the control terminal of the driving transistor is separately provided.

According to the first aspect of the invention, the first potential may be supplied to the potential supply line in at least the initialization period, and the second potential may be supplied to the potential supply line in at least the driving period. In other periods, the potential supply line may be set to either the first potential or the second potential. Further, the initialization period, the writing period and the driving period are not necessarily continuous on the time axis with no internal. The individual periods may be arranged with intervals,

Each of the plurality of unit circuits may have a capacitive element that has a first electrode connected to the control terminal of the driving transistor, and a second electrode that is kept at a constant potential in at least the driving period. According to this configuration, the potential of the control terminal of the driving transistor is kept by the capacitive element, and thus a driving state of the driven element (for example, an optical state of an electro-optical element) can be kept at a sufficient time length over a predetermined time length.

The second electrode of the capacitive element may be connected to a first wiring line different from one first wiring line among the plurality of first wiring lines. According to this configuration, since the first wiring line is also used as a wiring line that keeps the second electrode at the constant potential in at least the driving periods the number of wiring lines can be reduced, as compared with the configuration in which a separate wiring line from the first wiring line is connected to the second electrode. However, this is not intended to exclude the configuration, in which a separate wiring line from the first wiring line is connected to the second electrode, from the scope of the invention.

The second electrode of the capacitive element may be connected to a different first wiring line that is selected immediately before one first wiring line among the plurality of first wiring lines. According lo this configuration, a period where the second electrode is kept at the constant potential (that is, a period where the first wiring line selected immediately before one first wiring line is selected next time) can be sufficiently secured.

The potential setting unit may have a second switching element (for example, a transistor Tr2 of FIG. 2) that electrically connects one potential supply line and the second terminal of the driving transistor to each other in the initialization period and the driving period, and electrically isolates one potential supply line and the second terminal of the driving transistor from each other in the writing period. According to this configuration, the electronic connection (conduction or non-conduction) between the potential supply line and the second terminal of the driving transistor can be controlled by a simple configuration.

The potential setting unit of each unit circuit has a third switching element (for example, a transistor Tr3 of FIG. 23) that electrically connects the first terminal and the control terminal of the driving transistor to each other in the initialization period and the writing period, and electrically isolates the first terminal and the control terminal of the driving transistor from each other in the driving period. According to this configuration, if the second switching element and the third switching element are turned on, the potential supply line and the control terminal of the driving transistor are electrically connected to each other. Meanwhile, if the second switching element is turned on, the potential supply line and the second terminal of the driving transistor are electrically connected to each other. In addition, if the first switching element and the third switching element are turned on in the writing period, the control terminal of the driving, transistor is set to a potential according to the data signal and a threshold voltage of the driving transistor. Therefore, a variation in the threshold voltage of the driving transistor is compensated, such that the driven element can be driven with high accuracy in a predetermined state.

Each of the plurality of unit circuits may have a fourth switching element (for example, a transistor Tr4 of FIG. 2) that controls an electrical connection of the first terminal of the driving transistor and the driven element. According to this configuration, driving and stopping of the driven element can be reliably con-trolled according to the state of the fourth switching element.

The first switching element and the fourth switching element may be two transistor of different conductivity types, and gates of the two transistors may be commonly connected to one first wiring line. According to this configuration, since the first switching element and the fourth switching element operate in a complementary manner, and thus the number of wiring lines can be reduced, as compared with the configuration in which the individual elements are connected to separate wiring lines and are controlled by signals of separate channels.

The plurality of potential supply lines may intersect the plurality of second wiring lines. According to this configuration, in the initialization period and the driving period of each of the unit circuits connected one first wiring line (that is, the unit circuits having the writing periods at the same timing), the potential supply line can be reliably set to a predetermined potential (the first potential or the second potential).

The electronic devices described above are used in various electronic apparatuses. A representative one of the electronic apparatuses is an apparatus that uses the electronic device as a display device. As such an electronic apparatus, a personal computer or a cellular phone is exemplified. Besides, the use of the electronic device according to the aspect of the invention is not limited to image display. For example, the electronic device according to the aspect of the invention can be applied to an exposure device (an exposure head) that forms a latent image on an image carrier, such as a photosensitive drum or the like, through irradiation of light beams.

The driven element according to the first aspect of the invention includes all electrically driven parts. A representative one of the driven elements is an electro-optical element (for example, an OLED element), in which optical characteristics, such as luminance or transmittance, change due to an electric energy. Another aspect of the invention is also specified as an electro-optical device that is exclusively used for driving the electro-optical element. According to a second aspect of the invention, an electro-optical device includes a plurality of scanning lines, a plurality of data lines that intersect the plurality of scanning lines, a plurality of potential supply line, a plurality of unit circuits that are correspondingly arranged at intersections of the plurality of scanning lines and the plurality of data lines, a scanning line driving circuit that selects each of the plurality of scanning lines, a data line driving circuit that supplies a data signal to each of the plurality of data lines in each writing period, and a voltage control circuit that sets each of the plurality of potential supply lines to have a plurality of potentials. Each of the plurality of unit circuits has a driving transistor that has a control terminal, a first terminal, and a second terminal, a conduction state between the first terminal and the second terminal changing according to a potential of the control terminal, a driven element that is driven according to the conduction state of the driving transistor, a first switching element that electrically connects the first terminal of the driving transistor and the data lines to each other in a writing period where one scanning line among the plurality of scanning lines is selected, and a potential setting unit that electrically connects one potential supply line among the plurality of potential supply line and the control terminal of the driving transistor to each other in an initialization period before the start of the writing period, and electrically isolates one potential supply line and the second terminal of the driving transistor from each other in the driving period after the writing period. More specifically, the voltage control circuit supplies a first potential to one potential supply line in the initialization period, and supplies a second potential different from the first potential to one potential supply line in the driving period.

According to this configuration, the potential supply line that supplies the second potential to the second terminal of the driving transistor in the driving period is also used as a wiring line that supplies the first potential to the control terminal of the driving transistor in the initialization period. Therefore, like the electronic device of the invention, the configuration of each unit circuit can be simplified, as compared with the configuration in which the part for initializing the potential of the control terminal of the driving transistor is separately provided.

Another aspect of the invention is also realized as a method of driving an electronic device. According to a third aspect of the invention, a method of driving an electronic device, which has a driving transistor having a control terminal, a first terminal, and a second terminal, a conduction state between the first terminal and the second terminal changing according to a potential of the Control terminal, and a unit circuit having a driven element to be driven according to the conduction state of the driving transistor, includes supplying a first potential to a potential supply line in an initialization period, and electrically connecting the potential supply line and the control terminal of the driving transistor to each other, electrically connecting a data line to which a data signal is supplied, and the first terminal of the driving transistor to each other in a writing period after the initialization period, and supplying a second potential different from the first potential to the potential supply line in a driving period after the writing period, and electrically connecting the potential supply line and the second terminal of the driving transistor in the driving period so as to drive the driven element. According to this method, the same advantages as the electronic device of the invention can be obtained.

According to a fourth aspect of the invention, an electronic device includes a signal line (for example, a data line 15 of FIG. 8, a voltage supply line, a data supply circuit (for example, a data line driving circuit 25 of FIG. 8) that supplies a data voltage (for example, a voltage Vdata of a second or third embodiment) to the signal line in a writing period, a voltage control circuit that sets a voltage of the voltage supply line to a first voltage level in at least a part of the writing period, and changes the voltage of the voltage supply line to a second voltage level different from the first voltage level after the writing period, and a unit circuit. The unit circuit has a driving transistor that has a control terminal, a first terminal, and a second terminal, a conduction state between the first terminal and the second terminal changing according to a voltage of the control terminal, a driven element that is driven according to the conduction state of the driving transistor, a voltage setting unit (for example, a transistor Tr1 and a transistor Tr2 in the second or third embodiment) that electrically connects one of the first terminal and the second terminal and the signal line to each other in at least a part of the writing period so as to supply a data voltage to the control terminal through the other terminal of the first terminal and the second terminal, and a capacitive element that has a first electrode connected to the control terminal and a second electrode connected to the voltage supply line.

According to this configuration, in the writing period, after the voltage Supply line is set to the first voltage, the control terminal of the driving transistor is set to a voltage according to the data voltage (for example, a voltage according to the data voltage and the threshold voltage of the driving transistor). Then, if the voltage of the voltage supply line is set to the second voltage different from the first voltage after the writing period, the voltage of the control terminal changes the amount of the change in voltage of the voltage supply line due to capacitive coupling by the capacitive element, and thus the conduction state of the driving transistor is set to a separate state different from that of the writing period. Therefore, according to the above-described electronic device, for example, an element, such as the switching element interposed between the driving transistor and the driven element, that causes the unit circuit to be complicated does not need to be provided, the driving states of the driven element (driving or stopping) in the writing period and the period after the writing period can be distinguished. For example, in the writing period, control terminal is set to have the voltage according to the data voltage such that the voltage of the first terminal becomes a voltage for stopping the driven element. Then, after the writing period, the voltage of the control terminal is changed such that the voltage of the first terminal becomes a voltage capable of driving the driven element by the change in voltage of the voltage supply line. To the contrary, the driven element may be driven in the writing period, and the driven element may be stopped after the writing period.

According to the above-described electronic device, even though the electrical connection between the first terminal of the driving transistor and the driven element is not controlled by a specified element, the driving states of the driven element in the writing period and the period after the writing period can be distinguished. Therefore, a switching element may not be interposed between the first terminal of the driving transistor and the driven element. According to this configuration, the configuration of the unit circuit can be simplified or the aperture ratio can be improved. Moreover, this is not intended to exclude the configuration, in which an element is interposed between the driving transistor and the driven element so as to control the electrical connection between them, from the scope of the invention. That is according to aspect of the invention, although the driving states of the driven element in the writing period and the period after the writing period can be distinguished by the control of the voltage of the control terminal, in view of realizing a reliable control of the driven element by making the distinguishment more clear, an element (switching element) may be interposed between the driving transistor and the driven element so as to control the electrical connection between them.

The first electrode may be in a floating state after the writing period. According to this configuration, after the writing period, leakage of charges of the first electrode can be prevented, and the voltage of the control terminal can be reliably changed with high accuracy according to a change of the voltage of the voltage supply line.

In the above-described electronic device, the driven element may be driven, for example, when a voltage level of the first terminal is more than a predetermined voltage level (the second embodiment and the third embodiment). More specifically, in a configuration, in which an element having an anode electrically connected to the first terminal and a cathode supplied with a constant voltage (for example a ground voltage) is used as the driven element, the element is driven when voltage level higher than a voltage level of the cathode is supplied to the first terminal, or when a voltage level higher than the sum of the voltage level of the cathode and the threshold voltage of the driven element is supplied to the first terminal in this configuration, if the second voltage level is set to be higher than the first voltage level, the driven element can be driven after the writing period, and driving of the driven element can stop or can be suppressed in the writing period.

For example, the voltage setting unit may have a first switching element (for example, a transistor Tr1 of the second or third embodiment) that electrically connects the second terminal and the signal line to each other in the writing period), and the sum of the data voltage and the threshold voltage of the driving transistor may be less than the threshold voltage of the driven element. According to this configuration, in the writing period, driving of the driven element can reliably stop. Moreover, a specific example of this configuration is described below as the second embodiment (FIG. 10). Further, the voltage setting unit may have a first switching element that electrically connects the first terminal and the signal line to each other in the writing period, and the data voltage may be less than the threshold voltage of the driven element. According to this configuration, in the writing period, driving of the driven element can reliably stop. Moreover, a specific example of this configuration is described below as the third embodiment (FIG. 15).

The voltage setting unit may have a first switching element that controls an electrical connection between one of the first terminal and the second terminal and the signal line to each other (for example, electrically connects them in the writing period), and a second switching element (for example, a transistor Tr2 of the second or third embodiment) that controls an electrical connection between the other terminal of the first terminal and the second terminal and the control terminal (for example, electrically connects them in the writing period). The first switching element and the second switching element may be controlled by a signal to be supplied to a single wiring line. According to this configuration, the data line and the control terminal can be reliably connected to each other by the first switching element and the second switching element. Further, since the first switching element and the second switching element are commonly controlled by the signal to be supplied to the single wiring line, the number of wiring lines can be reduced or and the control can be simplified, as compared with the configuration in which the switching elements are individually controlled by signals of separate channels,

The voltage setting unit may have a third switching element (for example, a transistor Tr3 in the second or third embodiment) that electrically connects a feed line supplied with a predetermined voltage (for example, a power line 181 in the second embodiment or the voltage supply line 17 in the third embodiment) and the second terminal after the writing period. The first switching element, the second switching element, and the third switching element may be controlled by a signal to be supplied to a single wiring line. According to this configuration, since the second terminal of the driving transistor is set to a predetermined voltage after the writing period, the conduction state of the driving transistor (and the driving state of the driven element) can be stably kept. In addition, since the first switching element, the second switching element, and the third switching element are controlled by the signal to be supplied to the single wiring line, the number of wiring lines can be reduced or and the control can be simplified, as compared with the configuration in which the switching elements are individually controlled by signals of separate channels. More specifically, the third switching element is a transistor having a conductivity type different from the first switching element and the second switching element.

The unit circuit may have a reset unit that sets the voltage of the control terminal to a predetermined voltage level before the writing period. According to this configuration, since the control terminal is initialized to a predetermined voltage before the writing period, the control terminal can be reliably and rapidly set to a voltage according to the data voltage in the writing period. For example, the reset unit is a switching element (for example, a transistor Tres in the second or third embodiment) that controls the electrical connection between a wiring line supplied with a predetermined voltage and the control terminal.

In the above-described configurations, the driven element that is driven when the voltage of the first terminal is higher than the predetermined value is illustrated. To the contrary, however, a driven element that is driven when the voltage of the first terminal is lower than the predetermined value may be used. More specifically, a driven element that has an anode electrically connected to the first terminal and a cathode supplied with a constant voltage (for example, a power supply voltage) may be used (for example, FIG. 17 or 18). In this configuration, the second voltage is lower than the first voltage. Therefore, like the above-described configurations the driven element can be driven after the writing period, and driving of the driven element can stop or can be suppressed in the writing period.

The electronic device according to the aspect of the invention is used in various electronic apparatuses. A representative one of the electronic apparatuses is an apparatus that uses the electronic device as a display device. As such an electronic apparatus a personal computer or a cellular phone is exemplified. Moreover, the use of the electronic device according to the aspect of the invention is not limited to image display. For example, the electronic device of the invention can be applied to an exposure device (an exposure head) that forms a latent image on an image carrier, such as a photosensitive drum or the like, through irradiation of light beams.

The driven element according to the aspect of the invention includes all electrically driven parts. A representative one of the driven elements is an electro-optical element (for example, an OLED element), in which optical characteristics, such as luminance or transmittance, change due to an electric energy. Another aspect of the invention is also specified as an electro-optical device that is exclusively used for driving the electro-optical element. According to a fifth aspect of the invention, an electro-optical device includes data lines, voltage supply lines, a data line driving circuit that supplies a data voltage to each of the data lines in a writing period, a voltage control circuit that sets a voltage of each of the voltage supply lines to a first voltage level in at least a part of the writing period, and changes the voltage of the voltage supply line to a second voltage level different from the first voltage level after the writing period, and unit circuits. Each of the unit circuits has a driving transistor that has a control terminal, a first terminal, and a second terminal, a conduction state between the first terminal and the second terminal changing according to a voltage of the control terminal, an electro-optical element that is driven according to the conduction state of the driving transistor, a voltage setting unit that electrically connects one of the first terminal and the second terminal, and the data line in the writing period so as to sup ply the data voltage to the control terminal through the other terminal of the first terminal and second terminal, and a capacitive element that has a first electrode connected to the control terminal and a second electrode connected to the voltage supply line. According to this configuration, the same advantages as the electronic device of the invention can be obtained.

Another aspect of the invention is also specified as a method of driving an electronic device. According to a sixth aspect of the invention, a method of driving an electronic device, which has a driving transistor having a control terminal, a first terminal and a second terminal, a conduction state between the first terminal and the second terminal changing according to a voltage of the control terminal, and a unit circuit having a driven element to be driven according to the conduction state of the driving transistor, includes supplying a data voltage to a signal line, and electrically connecting one of the first terminal and the second terminal and the signal line to each other so as to supply the data voltage to the control terminal through the other terminal of the first terminal and the second terminal in a writing period, and changing the voltage of the control terminal by a predetermined amount so as to set the conduction state of the driving transistor after the writing period. More specifically, the unit circuit may have a capacitive element that has a first electrode connected to the control terminal and a second electrode connected to the voltage supply line. Then, the voltage of the voltage supply line is set to the first voltage level in at least a part of the writing period, and the voltage of the voltage supply line is changed to the second voltage level different from the first voltage level after the writing period so as to cause the voltage of the control terminal to be charged. According to this method of driving an electronic device, like the electronic device of the invention, for example, an element, such as the switching element interposed between the driving transistor and the driven element, that causes the unit circuit to be complicated do not need to be provided, the driving states of the driven element (driving or stopping) in the writing period and the period after the writing period can be distinguished.

### BRIEF DESCRIPTION OF THE DRAWINGS

The invention will be described with reference to the accompanying drawings, wherein like numbers reference like elements.

FIG. 1 a block diagram showing the configuration of an electronic device according to a first embodiment of the invention.

FIG. 2 is a circuit diagram showing the configuration of one unit circuit,

FIG. 3 is a timing chart illustrating the operation of the electronic device.

FIG. 4 is a circuit diagram showing a state of the unit circuit in an initialization period.

FIG. 5 is a circuit diagram showing a state of the unit circuit in a writing period.

FIG. 6 is a circuit diagram showing a state of the unit circuit in a driving period.

FIG. 7 is a circuit diagram showing the configuration of a unit circuit according to a comparative example of the first embodiment.

FIG. 8 is a block diagram showing the configuration of an electronic device according to a second embodiment of the invention.

FIG. 9 is a diagram showing high and low levels of an individual voltage used in the electronic device.

FIG. 10 is a circuit diagram showing the configuration of one unit circuit.

FIG. 11 timing chart illustrating the operation of the electronic device.

FIG. 12 is a circuit diagram showing a state of the unit circuit in an initialization period.

FIG. 13 is a circuit diagram showing a state of the unit circuit in a writing period.

FIG. 14 is a circuit diagram showing a state of the unit circuit in a driving period.

FIG. 15 is a circuit diagram showing the configuration of one unit circuit in a third embodiment of the invention.

FIG. 16 is a circuit diagram showing a state of the unit circuit in a writing period according to the third embodiment of the invention.

FIG. 17 is a circuit diagram partially showing the configuration of a unit circuit according to a modification.

FIG. 18 is a circuit diagram partially showing the configuration of a unit circuit according to a modification.

FIG. 19 is a perspective view showing a specific example of an electronic apparatus according to an embodiment of the invention.

FIG. 20 is a perspective view showing a specific example of an electronic apparatus according to an embodiment of the invention.

FIG. 21 is a perspective view showing a specific example of an electronic apparatus according to an embodiment of the invention.

FIG. 22 is a circuit diagram partially showing the configuration of a unit circuit according to the related art.

### DETAILED DESCRIPTION OF EMBODIMENTS

### First Embodiment

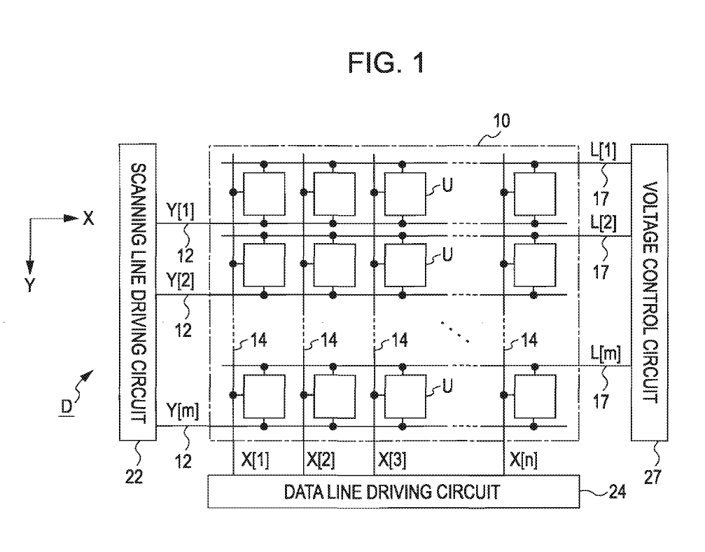

FIG. 1 is a block diagram showing the configuration of an electronic device according to a first embodiment of the invention. An electronic device D of FIG. 1 is an electro-optical device that is used in various electronic apparatuses as a unit for displaying images. The electronic device D includes an element array portion 10a, in which a plurality of unit circuits U are arranged in a planar manner, a scanning line driving circuit 22 and a data line driving circuit 24 that drive the individual unit circuits U, a voltage control circuit 27 that controls potentials to be supplied to the individual unit circuits U.

As shown in FIG. 1, in the element array portion 10, m scanning lines 12 extending in an X direction, m potential supply lines 17 extending in the X direction to be in pairs with the scanning lines 12, n data lines 14 extending in a Y direction perpendicular to the X direction are formed (where m and n are natural numbers). The unit circuits U are correspondingly disposed at intersections of the pairs of the scanning lines 12 and the potential supply lines 17 and the data lines 14. Therefore, the unit circuits U are arranged in a matrix shape of vertical m rows×horizontal n columns.

The scanning line driving circuit 22 is a circuit that sequentially selects the plurality of scanning lines 12 (that is, a circuit that selects the plurality of unit circuits U in units of rows). Meanwhile, the data line driving circuit 24 generates data signals X[1] to X[n] corresponding to the unit circuits U of one row (n unit circuits) connected to the scanning line 12 selected by the scanning line driving circuit 22 and outputs the data signals X[1] to X[n] to the individual data lines 14. In a period where the scanning line 12 of the i-th row (where j is an integer satisfying the condition 1≦i≦m) is selected (a writing period P2 described below), the data signal X[j] that is supplied to the data line 1]4 of the j-th column (where j is an integer satisfying the condition 1≦i≦n) becomes a potential Vdata corresponding to a gray-scale level assigned to the unit circuit U of the j-th column belonging to the i-th row. The gray-scale level of each of the unit circuits U is assigned by gray-scale data to be supplied from the outside.

The voltage control circuit 27 is a circuit that supplies potentials L[1] to L[m] to the plurality of potential supply lines 17. Each of the potentials L[1] to L[m] is sequentially switched from on one of a low power-supply potential (hereinafter, referred to as ‘first potential’) Vss and a high power-supply potential (hereinafter, referred to as ‘second potential’) Vdd to the other.

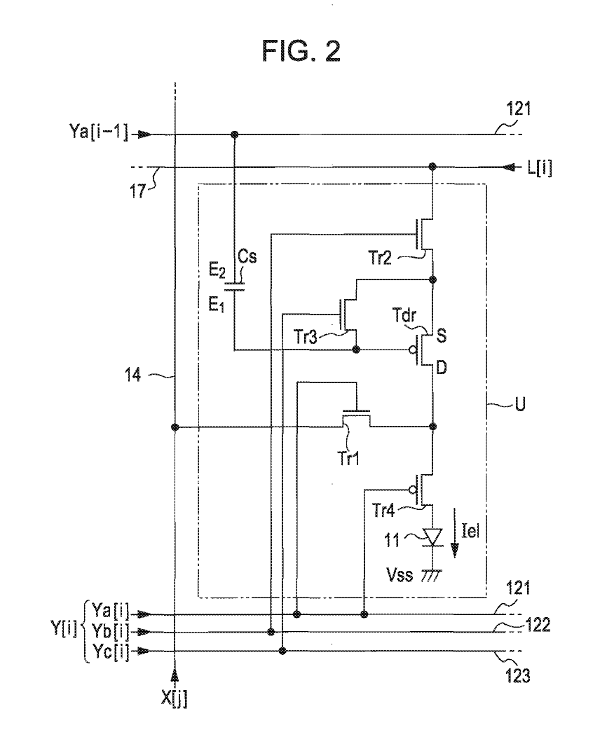

Next, the specific configuration of each of the unit circuits U will be described with reference to FIG. 2. In FIG. 2, only one unit circuit U of the i-th row and the j-th column is shown, but other unit circuits U have the same configuration. Further, the conduction type of each transistor constituting the unit circuit U can be appropriately changed from the example of FIG. 2.

As shown in FIG. 2, the unit circuit U includes an electro-optical element 11 that is interposed between the potential supply line 17 and a ground line (potential Vss). The electro-optical element 11 is a current-driven-type driven element that emits light at luminance according to a driving current Iel to be supplied thereto. In this embodiment, the electro-optical element 11 is an OLED element, in which a light-emitting layer folded of an organic electroluminescent material is interposed between an anode and a cathode.

Although the scanning line 12 is shown as one wiring line for convenience in FIG. 1, as shown in FIG. 2, the scanning line 12 actually includes three wiring lines (a first control line 121, a second control line 122, and a third control line 123). To the wiring lines, predetermined signals are supplied from the scanning line driving circuit 22. That is, a first control signal Ya[i] is supplied to the first control line 121 constituting the scanning line 12 of the i-th row, a second control signal Yb[i] is supplied to the second control line 122 of the same row, and a third control signal Yc[i] is supplied to the third control line 123 of the same row. Specific waveforms of the individual signals or the operation of the unit circuit U according to the signals will be described below.

As shown in FIG. 2, in a path from the potential supply line 17 to the anode of the electro-optical element 11, a p-channel driving transistor Tdr is interposed. In the driving transistor Tdr, a conduction state of a source S and a drain D changes according to a potential Vg of a gate (hereinafter, referred to as ‘gate potential’), and the driving current Iel according to the gate potential Vg is generated. That is, the electro-optical element 11 is driven according to the conduction state of the driving transistor Tdr (that is, at a gray-scale level according to the gate potential Vg).

An n-channel transistor Tr1 is interposed between the drain of the driving transistor Tdr and the data line 14 so as to control the electrical connection (conduction and non-conduction) between them. A gate of the transistor Tr1 is connected to the first control line 121. Therefore, if the first control signal Ya[i] is in the high level, the transistor Tr1 is turned on, the potential Vdata of the data signal X[j] is supplied to the drain of the driving transistor Tdr. Further, if the first control signal Ya[i] is in the low level, the drain of the driving transistor Tdr is electrically isolated from the data line 14. Moreover, since the potential L[i] of the potential supply line 17 changes from one of the first potential Vss and second potential Vdd to the other, in the strict sense, the drain and the source of the driving transistor Tdr are switched according to the potential L[i] as the occasion demands. In this embodiment, however, for convenience, the drain and the source of the driving transistor Tdr are defined on the basis of high and low levels of a potential in a period where the potential L[i] of the potential supply line 17 is the second potential Vdd (writing, period P2).

A first electrode E1 of a capacitive element Cs is connected to the gate of the driving transistor Tdr. The capacitive element Cs is a unit that holds charges according to the gate potential Vg of the driving transistor Tdr (that is, a unit that holds the gate potential Vg). A second electrode E2 of the capacitive element Cs is connected to the first control line 121 of the (i-1)th row adjacent to the unit circuit U. However, in each of the unit circuits U belonging to the first row, the second electrode E2 of the capacitive element Cs is connected to a predetermined wiring line (not shown), to which a constant potential is supplied. Moreover, when the gate potential Vg is held by gate capacitance of the driving transistor Tdr or parasitic capacitance of the wiring line connected to the gate thereof, the capacitive element Cs may be independently disposed.

Meanwhile, an n-channel transistor Tr2 is connected between the source of the driving transistor Tdr and the potential supply line 17 of the i-th row so as to control the electrical connection between them. A gate of the transistor Tr2 is connected to the second control line 122. Therefore, if the second control signal Ab[i] is in the high level, the transistor Tr2 is turned on and the source of the driving transistor Tdr and the potential supply line 17 are electrically connected to each other. Further, if the second control signal Yb[i] is in the low level, the transistor Tr2 is turned off, and both are electrically isolated from each other,

An n-channel transistor Tr3 is interposed between the gate and the source of the driving transistor Tdr so as to control the electrical connection between them. A gate of the transistor Tr3 is connected to the third control line 123. Therefore, if the third control signal Yc[i] is changed to the high level, the transistor Tr3 is turned on, and the driving transistor Tdr is brought into diode connection. Further, if the third control signal Yc[i], is changed to the low level, the transistor Tr3 is turned oft, and the diode connection of the driving transistor Tdr is released. If both the transistor Tr2 and the transistor Tr3 are turned on, the gate of the driving transistor Tdr is electrically connected to the potential supple line 17. That is, the transistor Tr2 and the transistor Tr3 constitute a unit (potential setting unit) that sets the gate potential Mg to the potential L[i] of the potential supply line 17.

A p-channel transistor Tr4 is interposed between the drain of the driving transistor Tdr and the anode of the electro-optical element 11 so as to control the electrical connection between them. Like the transistor Tr2, a gate of the transistor Tr4 is connected to the first control line 121. Therefore, when the first control signal Ya[i] is kept at the low level, the transistor Tr4 is turned on, and the driving current Iel can be supplied to the electro-optical element 11. In contrast when the first control signal Ya[i] is kept at the high level, the transistor Tr4 is turned off. Then, the path of the driving current Iel is cut off, and the electro-optical element 11 is turned off.

Since the transistor Tr1 and the transistor Tr4 are opposite conductivity types, a common signal (the first control signal Ya[i]) is supplied to them, and the conduction states of them are changed in a complementary manner. That is, if the transistor Tr1 is turned on, the transistor Tr4 is turned off. Further, if the transistor Tr1 is turned off, the transistor Tr4 is turned on. When the transistor Tr1 and the transistor Tr4 are the same conductivity type, additional wiring lines need to be provided so as to control them separately. In contrast, in this embodiment, since one wiring line (first control line 121) is used to control the transistor Tr1 and the transistor Tr4, the number of wiring lines is reduced, and thus the configuration of the electronic device D can be simplified.

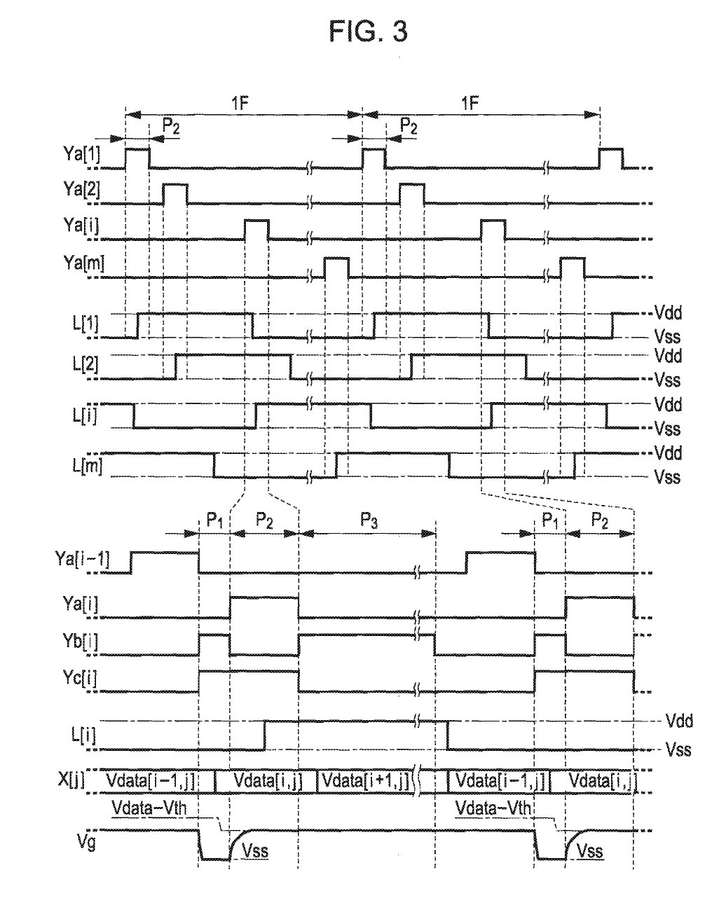

Next, specific waveforms of the individual signals that are used in the electronic device D will be described with reference to FIG. 3. As shown in FIG. 3, the first control signals Ya[1] to Ya[m] sequentially become the high level for each writing period P2. That is, the first control signal Ya[i] is kept at the high level in the i-th writing period P2 of the vertical scanning period (1F) but is kept at the low level in other periods. The change of the first control signal Ya[i] to the high level means the selection of the i-th row.

As shown in FIG. 3, the second control signal Yb[i] becomes the high level in a period (hereinafter, referred to as ‘initialization period’) P1 before the start of the writing period P2 where the first control signal Ya[i] becomes the high level, a period (hereinafter, referred to as ‘driving period’) P3 after the writing period P2, but is kept at the low level in other periods (in particular, the writing period P2). Meanwhile, the third control signal Yc[i] becomes the high level in the writing period P2 where the first control signal Ya[i] becomes the high level and the initialization period P1 immediately before the writing period P2, but is kept at the low level in other periods (in particular, the driving period P3). Moreover, although a period from the start point of the writing period P2 to the end point of the next writing period P2 is set to the initialization period P1 in this embodiment, an interval may exist between the initialization period P1 and the writing period P2. Similarly, an interval may exist between the writing period P2 and the driving period P3. If a time interval is provided between the initialization period P1 and the writing period P2, the gate potential Vg of the driving transistor Tdr can be reliably initialized in the initialization period P1. Further, if a time interval is provided between the writing period P2 and the driving period P3, the gate potential Vg can be reliably set to a potential according to the data signal X[j] in the writing period P2.

As shown in FIG. 3, the potential L[i] of the potential supply line 17 of the i-the row repeats a cycle of a change from the first potential Vss to the second potential Vdd in the middle of the writing period P2 where the first control signal Ya[i] becomes the high level, and a change from the second potential Vdd to the first potential Vss after the driving period P3 immediately after the writing period P2. Therefore, the potential L[i] of the potential supply line 17 of the i-th row keeps the first potential Vss over the entire initialization period P1 and keeps the second potential Vdd over the entire driving period P3.

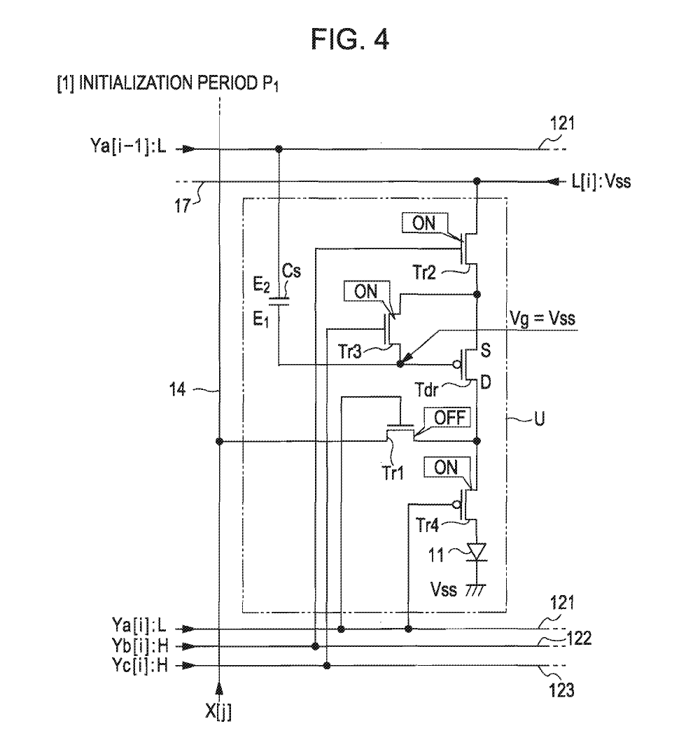

Next, the specific operation of the electronic device D will be described with reference to FIGS. 4 to 6. In the following description, the operation of the unit circuit U of the j-th column belonging to the i-th row will be described for each of the initialization period P1, the writing period P2, and the driving period P3.

(a) Initialization Period P1 (FIG. 4)

In the initialization period P1, the first control signal Ya[i] keeps the low level, the transistor Tr1 is turned off and the transistor Tr4 is turned on, as shown in FIG. 4, Meanwhile, in the initialization period P1, the second control signal Yb[i] and the third control signal Yc[i] are kept at the high level. Therefore, as shown in FIG. 4, both the transistor Tr2 and the transistor Tr3 are turned on. Accordingly, the gate of the driving transistor Tdr is electrically connected to the potential supply line 17.

Meanwhile, as shown in FIGS. 3 and 4, in the initialization period P1, the potential L[i] of the potential supply line 17 keeps the first potential Vss by the voltage control circuit 27. Therefore, the gate potential Vg of the driving transistor Tdr is set to the first potential Vss. That is, at the start point of the initialization period P1, the gate potential Vg is initialized to the first potential Vss, regardless of the charges accumulated in the capacitive element Cs (regardless of the voltage held in the capacitive element Cs according to the data signal X[j] in the previous writing period P2).

Moreover, in the initialization period P1, both the transistor Tr2 and the transistor Tr4 are turned on, and a path from the potential supply line 17 to the electro-optical element 11 is formed. However, the potential L[i] of the potential supply line 17 is kept at the same potential (the first potential Vss) as the cathode of the electro-optical element 11, and thus the driving current Iel does not flow in the elect,o-optical element 11. Therefore, the electro-optical element 11 does not emit light in the initialization period P1.

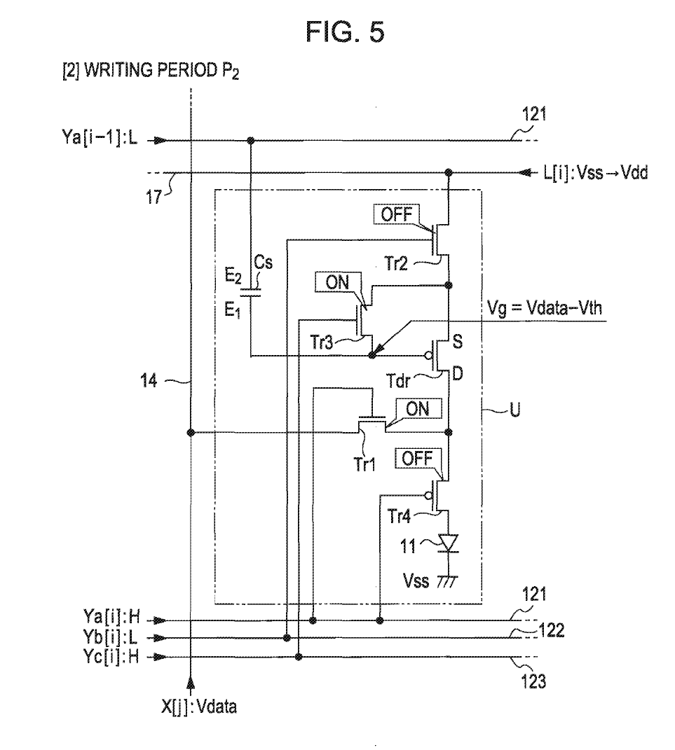

(b) Writing Period P2 (FIG. 5)

In the writing period P2, the second control signal Yb[i] is changed to the low level. Therefore, as shown in FIG. 5, the transistor Tr2 is turned off. In a state where the unit circuit U is electrically isolated from the potential supply line 17 in such a manner, the potential L[i] of the potential supply line 17 is changed from the first potential Vss to the second potential Vdd by the voltage control circuit 27.

As shown in FIG. 3, in the writing period P2 where the first control signal Ya[i] becomes the high level, the data signal X[j] of the data line 14 of the j-th column is set to the potential Vdata (in FIG. 3, represented by Vdata[i,j]) according to the gray-scale level of the unit circuit U of the i-th row and the j-th column. Meanwhile, in the writing period P2, both the first control signal Ya[i] and the third control signal Yc[i] become the high level. Then, as shown in FIG. 4, the transistor Tr4 is turned off and the transistor Tr1 and the transistor Tr3 are turned on. Therefore, the gate of the driving transistor Tdr is electrically connected to the data line 14 through the transistor Tr3, the source and the drain of the driving transistor Tdr, and transistor Tr1. Accordingly, as shown in FIG. 3, the gate potential Vg of the driving transistor Tdr increases from the potential Vss set in the initialization period P1, and converges on a difference (Vg=Vdata−Vth) between the potential Vdata of the data signal X[j] and a threshold voltage Vth of the driving transistor Tdr. The writing period P2 is set to have a time length enough for the convergence of the gate potential Vg.

(c) Driving Period P3 (FIG. 6)

In the driving period P3, the first control signal Ya[i] becomes the low level. Therefore, the transistor Tr1 is turned off, and the unit circuit U is electrically isolated from the data line 14 accordingly. Further, the transistor Tr4 is turned on. In addition, if the third control signal Yc[i] is changed to the low level, the transistor Tr3 is turned off. Therefore, the diode connection of the driving transistor Tdr is released.

Meanwhile, in the driving period P3, the second control signal Yb[i] becomes the high level. Therefore, the transistor Tr2 is turned on, and the source of the driving transistor Tdr is electrically connected to the potential supply line 17. That is in the driving period P3, a path of the driving current Iel from the potential supply line 17 to the electro-optical element 11 through the transistor Tr2, the driving transistor Tdr, and the transistor Tr4. To the source of the driving transistor Tdr, the second potential Vdd, which serves as the potential L[i] of the potential supply line 17 at that time point, is supplied.

As shown in FIG. 3, the first control signal Ya[i−1] of the (i-1)th row keeps a constant level in both the writing period P2 and the driving period P3 of the i-th row. Therefore, the gate potential Vg set in the writing period P2 is kept at a potential (Vdata−Vth) according to data signal X[j] over the entire driving period P3. As such, since the conduction state of the driving transistor Tdr is set according to the data signal X[j], the driving current Iel corresponding to the potential Vdata is supplied from the potential supply line 17 to the electro-optical element 11 through the transistor Tr2, the driving transistor Tdr, and the transistor Tr4. Then, the electro-optical element 11 emits light at luminance according to the driving current Iel.

Now, if it is now assumed that the driving transistor Tdr operates in a saturation region, the driving current Iel that is supplied to the electro-optical element 11 in the driving period P3 is represented by the following equation (1). Moreover, in the equation (1), ‘β’ is a gain coefficient of the driving transistor Tdr, and ‘Vgs’ is a voltage between the gate and the source of the driving transistor Tdr,
Iel=(β/2)(Vgs−Vth)² (1)

In the driving period P3, the gate potential Vg is kept at ‘Vdata−Vth’ set in the writing period P2, and the potential L[i] (the second potential Vdd) is supplied to the source of the driving transistor Tdr through the transistor Tr2. Then, the voltage Vgs becomes ‘Vdd−(Vdata−Vth)’. If ‘Vdd−(Vdata−Vtn)’ is substittited for Vgs, and the equation (1) is modified to the following equation (2).
Iel=(β/2)(Vdd−Vdata)² (2)

That is, the driving current Iel does not depend on the threshold voltage Vth of the driving transistor Tdr. Therefore, according to this embodiment, a variation in the threshold voltage Vth in the unit circuit U is compensated, which makes it possible to cause the electro-optical element 11 at predetermined luminance with high accuracy. As described above, in this embodiment, the potential L[i] of the potential supply line 17 is sequentially switched from one of the first potential Vss and the second potential Vdd to the other. Then, in at least a part (initialization period P1) of a period where the potential L[i] is the first potential Vss, the gate of the driving transistor Tdr is connected to the potential supply line 17, and the gate potential Vg is initialized to the first potential Vss. Therefore, according to this embodiment, the gate potential Vg can be initialized, without complicating the configuration of the unit circuit U. The detailed description of the effect is given below.

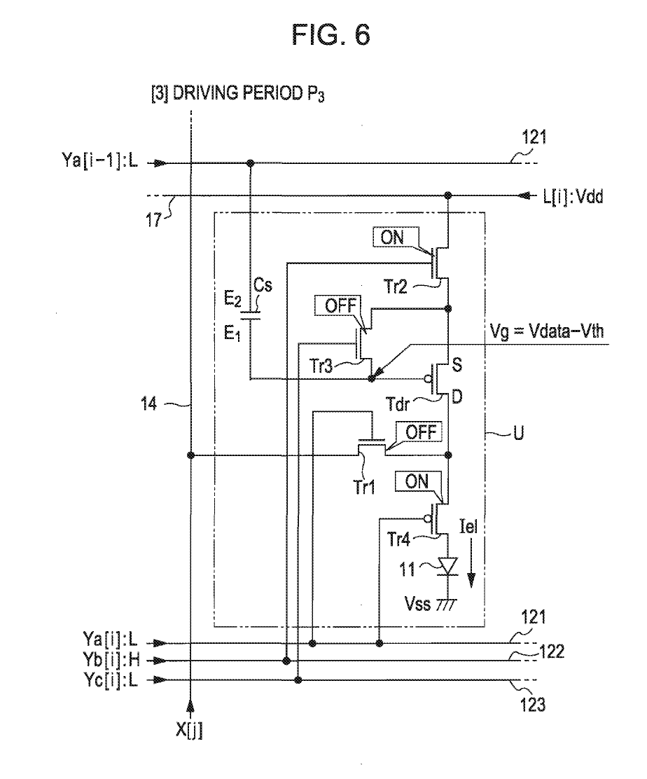

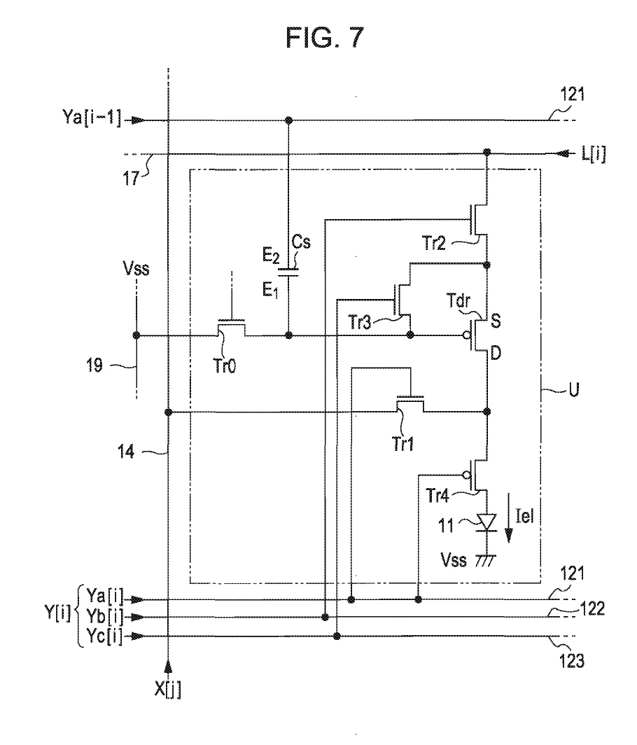

As a configuration that initializes the gate potential Vg to the first potential Vss, for example, a configuration shown in FIG. 7 can be considered. In this configuration, a transistor Tr0 is interposed between a constant potential 19 that is kept at the first potential Vss and the gate of the driving transistor Tdr. Then, in the initialization period P1, the transistor Tr0 is turned on, and the constant-potential line 19 and the gate of the driving transistor Tdr are electrically connected, such that the gate potential Vg is initialized to the first potential Vss. However, in this configuration, since the transistor Tr0 and a wiring line or the constant-potential line 19 that controls the transistor Tr0 need to be disposed, the configuration of the unit circuit U is complicated, which cause an increase in manufacturing costs or a decrease in yield. As a result, an aperture ratio is decreased. According to this embodiment, since the transistor Tr0 or the constant-potential line 19 does not need to be disposed, the problems inherent in the configuration of FIG. 7 can be effectively solved.

In addition, in this embodiment, the second electrode E2 of the capacitive element Cs that is kept at the gate potential Vg is connected to the first control line 121 of an adjacent row. Here, as the configuration that keeps the gate potential Vg, a configuration in which the second electrode E2 of the capacitive element Cs is electrically connected to the potential supply line 17 can be considered. However, according to this configuration, if the potential L[i] of the potential supply line 17 falls along with the supply of the driving current Iel in the driving period P3, the gate potential Vg of the driving transistor Tdr may change from a predetermined value (Vdata−Vth). In contrast, in this embodiment, since the second electrode E2 is connected to the first control line 121 that is not included in the path of the driving current Iel, a change in the gate potential Vg due to the supply of the driving current Iel is avoided. Therefore, the driving current Iel according to the potential Vdata of the data signal X[j] can be generated with high accuracy.

Moreover, a connection destination of the second electrode E2 may be a wiring line that allows the gate potential Vg to converge on ‘Vdata−Vth’ in the writing period P2 and to be substantially kept at a constant potential to the end point of the driving period P3. The connection destination of the second electrode E2 is not limited to the first control line 121 of the adjacent row. However, like this embodiment, according to the configuration in which the first control line 121 is also used as the wiring line for substantially keeping the second electrode E2 of the capacitive element Cs at the constant potential, the number of wiring lines of the electronic device D can be reduced, as compared with the configuration in which the wiring line serving as the connection destination of the second electrode E2 is formed separately from the individual control lines. Further, in this embodiment, in each of the unit circuits U of the i-th row, the second electrode E2 of the capacitive element Cs is connected to the first control line 121 of the (i-1)th row that is previously selected. Therefore, as compared with the configuration in which the second electrode E2 is connected to the first control line 121 of a row other than the (i-1)th row, the gate potential Vg is set to the potential (Vdata−Vth) of the data signal X[j], and thus the period where the second electrode E2 of each row is kept at the constant potential can be sufficiently secured.

Moreover, like this embodiment, when the driving transistor Tdr is the p-channel type, a high potential (that is, the second potential Vdd) may be supplied to the second electrode E2 in the writing period P2. In this configuration, when the transistor Tr1 is a p-channel type, and the transistor Tr4 is a n-channel type, the individual transistors are controlled in the same manner as the first embodiment.

Further, if the first control line 121 of the (i-1)th row is set to the first potential Vss in the initialization period P1 of the i-th row, a potential difference between the first electrode E1 and the second electrode E2 becomes zero, and it is a possibility that the capacitive element Cs cannot reliably keep a predetermined voltage. Therefore, the low level of the first control signal Ya[i] to be supplied to the first control line 121 may be set different from the first potential Vss.

Modifications

As regards the above-described embodiment, various modifications can be made. Specific modifications are as follows. Moreover, the modifications can be appropriately combined.

(1) First Modification

A specific configuration of the unit circuit is not limited to the configuration shown in FIG. 2. For example, in the above-described embodiment, the unit circuit U includes the transistor Tr2 and the transistor Tr3. In the modifications, a unit (potential setting unit) that connects the potential supply line 17 to the gate of the driving transistor Tdr in the initialization period P1, and connects the potential supply line 17 to the source of the driving transistor Tdr in the driving period P3 may be provided, and the specific configuration thereof is not particularly limited.

In addition, the transistor Tr1 and the transistor Tr4 are controlled by the common, signal (the first control signal Ya[i]) in the above-described embodiment, but the transistors Tr1 and Tr4 may be controlled by separate signals. Therefore, the transistor Tr1 and the transistor Tr4 may be the same conductivity type. Further, the transistor Tr4 may not be disposed (that is, the drain of the driving transistor Tdr and the electro-optical element 11 are directly connected to each other).

(2) Second Modification

In the above-described embodiment, the potential Li[i] of the potential supply line 17 is set to the first potential Vss serving as a low power supply potential in the initialization period P1, but the specific level of the first potential Vss maybe arbitrarily changed. However, the potential L[i] to be supplied to the gate of the driving transistor Tdr in the initialization period P1 is preferably a level that turns on the driving transistor Tdr, like the above-described configuration. According to this configuration, as compared with the configuration in which the potential L[i] is set to a level turning off the driving transistor Tdr in the initialization period P1, the gate potential Vg of the driving transistor Tdr can rapidly and reliably con verge on the potential to the potential (Vdata−Vth) according to the data signal X[i].

(3) Third Modification

In the above-described embodiment, the OLED element is illustrated as the electro-optical element 11, but an electro-optical element that is used in the electronic device of the invention is not limited to the OLED element. For example, instead of the OLED element, various self-luminescent elements, such as inorganic EL elements, field emission (FE) elements, SE (Surface-conduction Electron-emitter) elements, BS (Ballistic electron Surface emitting) elements, or LED (Light Emitting Diode) elements, or various electro-optical elements, such as electrophoretic elements or electrochromic elements, can be used. Further, the invention is applied to a sensing device, such as a biochip or the like. The driven element of the invention includes all parts that are driven by electric energy. The electro-optical elements, such as light-emitting elements or the like, are just for illustrative.

### Second Embodiment

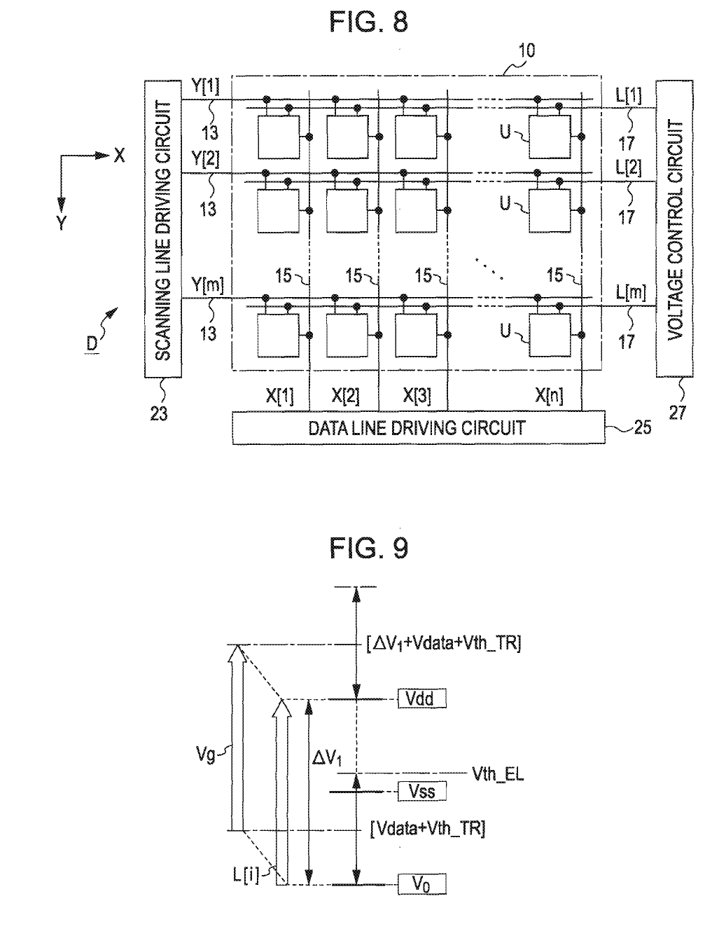

FIG. 8 is a block diagram showing the configuration of an electronic device according to a second embodiment of the invention. The electronic device D shown in FIG. 8 is an electro-optical device that is used in various electronic apparatuses as an image display unit. The electronic device D includes an element array portion 10 having a plurality of unit circuits U that are arranged in a planar manner, a scanning line driving circuit 23 and a data line driving circuit 25 that drive each of the unit circuit U, and a voltage control circuit 27 that controls a voltage to be supplied to each of the unit circuits U.

As shown in FIG. 8, in the element array portion 10, m scanning lines 13 extending in the X direction, m voltage supply lines 17 extending in the X direction to be in pairs with the scanning lines 13, n data lines 15 extending in the Y direction perpendicular to the X direction are formed (where m and n are natural numbers). The unit circuits U are correspondingly disposed at the intersections the pairs of the scanning lines 13 and the voltage supply lines 17, and the data lines 15. Therefore, the unit circuits U are arranged in a matrix shape of vertical m rows× and horizontal n columns.

The scanning line driving circuit 23 is a circuit that selects the plurality of scanning lines 13 in a predetermined sequence (selects the plurality of unit circuits U in units of rows). Meanwhile, the data line driving circuit 25 generates data signals X[1] to X[n] corresponding to the unit circuits U of one row (n unit circuits) connected to the scanning line 13 selected by the scanning line driving circuit 23 and outputs the data signals X[1] to X[n] to the individual data lines 15. In the period where the scanning line 13 of the i-th row (where i is an integer satisfying the condition 1≦i≦m) is selected, the data signal X[j] to be supplied to the data line 15 of the j-th column (where is an integer satisfying the condition 1≦j≦n) is a voltage signal of the voltage Vdata corresponding to the gray-scale level assigned to the unit circuit U of the i-th column belonging to the i-th row. The gray-scale level of each of the unit circuits U is assigned by gray-scale data to be supplied from the outside.

The voltage control circuit 27 is a circuit that commonly supplies a high power-supply voltage (hereinafter, referred to as ‘power supply voltage’) Vdd and a low power-supply voltage (hereinafter, referred to as ‘ground voltage’) Vss to the plurality of unit circuits U, and supplies voltages L[1] to L[m] to each of the plurality of voltage supply lines 17. In this embodiment, the ground voltage Vss serves as a reference potential of the voltage of each part.

FIG. 9 is a diagram showing high and low levels of each voltage to be used in the electronic device D. As shown in FIG. 9, each of the voltages L[1] to L[m] is sequentially switched from one of the power-supply voltage Vdd and a predetermined voltage (hereinafter, referred to as ‘writing voltage’) V0 to the other. In this embodiment, the writing voltage V0 is a voltage lower than the power-supply voltage Vdd by ‘ΔV1’. In addition the writing voltage V0 is lower than the ground voltage Vss.

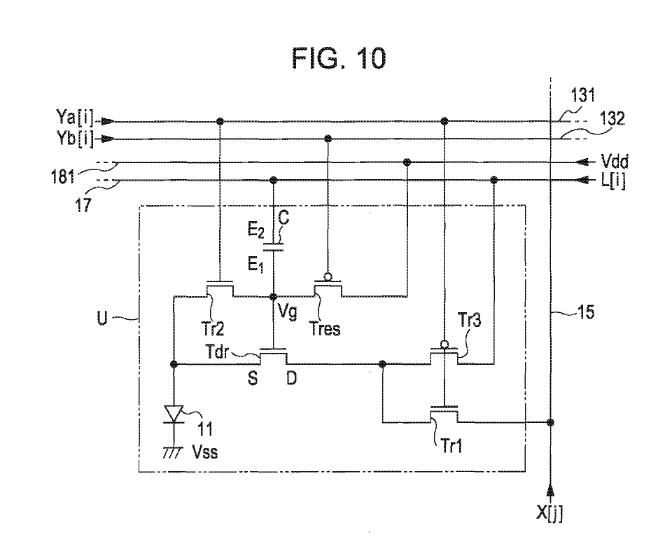

Next, the specific configuration of each unit circuit U will be described with reference to FIG. 10. Moreover, in FIG. 10, only one unit circuit U located at the i-th row and the j-th column is shown, but other unit circuits U have the same configuration. Further, a conductivity type of each transistor constituting the unit circuit U can be appropriately changed from the example shown in FIG. 10.

As shown in FIG. 10, the scanning line 13 that is shown as one wiring line in FIG. 8 for convenience actually includes two wiring lines (a first control line 131 and a second control line 132). To the first control line 131 and the second control line 132, signals are individually supplied from the scanning line driving circuit 23. That is, a first control signal Ya[i] is supplied to the first control line 131 constituting the scanning line 13 of the i-th row, and a second control signal Yb[i] Is supplied to the second control line 132 of the same row. Further, the voltage L[i] is supplied to the unit circuits U of the i-th row through the voltage supply line 17 of the i-th row, and the power-supply voltage Vdd is supplied to the unit circuits U through a common power line 1 81.

As shown in FIG. 10, each of the unit circuits U has an electro-optical element 11, a driving transistor Tdr, four transistors (Tr1, Tr2, Tr3, and Tres), and a capacitive element C. Among these, the electro-optical element 11 is a part (driven element) that is an object to be driven in the electronic device D. The electro-optical element 11 of this embodiment is a current-driven light-emitting element that emits light at luminance according to a current (hereinafter, referred to as ‘driving current) Iel to be supplied thereto. As such an electro-optical element 11, an OLED element, in which a light-emitting layer formed of an organic EL (Electroluminescent) material is interposed between an anode and a cathode is used. In each unit circuit U, the cathode of the electro-optical element 11 is commonly connected to a ground line to which the ground voltage Vss is supplied. The electro-optical element 11 emits light by the application of a forward voltage more than a threshold voltage Vth_EL.

The driving transistor Tdr (threshold voltage Vth_TR) of FIG. 10 is an n-channel transistor that controls the current amount of the driving current Iel. More specifically, in the driving transistor Tdr, the conduction state between the source and the drain changes according to the voltage Vg of the gate (hereinafter, referred to as ‘gate voltage’) and then the driving current Iel of the current value according to the gate voltage Vg is generated. Therefore, the electro-optical element 11 is driven according to the conduction state of the driving transistor Tdr (That is, at luminance according to the gate voltage Vg). Moreover, in this embodiment, since the high and low levels of each of the voltages of the source and the drain of the driving transistor Tdr change in a time-variant manner, in the strict sense, the drain and the source of the driving transistor Tdr are switched as the occasion demands. However, in the following description, in view of the fact that the conductivity type of the driving transistor Tdr is an n-channel type, or the high and low levels of the voltage of each of the terminals of the driving transistor Tdr when the driving current is supplied to the electro-optical element 11 through the driving transistor Tdr, for convenience of explanation, in the driving transistor Tdr, a terminal close to the electro-optical element 11 is represented by ‘source’ and an opposing terminal is represented by ‘drain’.

The source of the driving transistor Tdr is directly connected to the anode of the electro-optical element 11. That is, on a path of the driving current Ile from the source of the driving transistor Tdr to the anode of the electro-optical element 11, no switching element is interposed. Therefore, the electro-optical element 11 emits light when the voltage of the source of the driving transistor Tdr (that is, the voltage of the anode of the electro-optical element 11) is more than the threshold voltage Vth_EL of the electro-optical element 11. Moreover, if the characteristics of the electro-optical element 11 are selected such that the threshold voltage Vth_EL becomes equal to or less than the threshold voltage Vth_TR of the driving transistor Tdr, a lower limit value of the voltage Vdata of the data signal X[j] (for example, a voltage Vdata corresponding to a minimum gray-scale level) can be set to a high voltage.

The transistor Tr1 is a switching element that controls an electrical connection (conduction and non-conduction) between the drain of the driving transistor Tdr and the data line 15. Transistor Tr2 is a switching element that controls an electrical connection between the gate and the source of the driving transistor Tdr. Further, the transistor Tr3 is a switching element that controls an electrical connection between the drain of the driving transistor Tdr and the voltage supply line 17.

The gates of the transistor Tr1, the transistor Tr2, and the transistor Tr3 are commonly connected to the first control line 131. Meanwhile the conductivity types of the transistor Tr1 and the transistor Tr2 are n-channel types, and the conductivity type of the transistor Tr3 is a p-channel type. Therefore, the conduction states of the transistor Tr1, the transistor Tr2, and the transistor Tr3 are switched in a complementary manner. That is, if the first control signal Ya[i] is in the high level, the transistor Tr1 and the transistor Tr2 are turned on, and the transistor Tr3 is turned off. In contrast, if the first control signal Ya[i] is in the low level, the transistor Tr1 and the transistor Tr2 are turned off, and the transistor Tr3 is turned on. In this embodiment, since the three transistors Tr1, Tr2, and Tr3 are connected to the single wiring line and are controlled by the common signal (the first control signal Ya[i]), as compared with the configuration in which the transistors are connected to separate wiring lines and are controlled by signals of separate channels, the number of wiring lines can be reduced or the control can be simplified. As a result, an aperture ratio can be improved or yield can be improved.

As shown in FIG. 10, the first electrode E1 of the capacitive element C is connected to the gate of the driving transistor Tdr. The capacitive element C is a unit that holds charges according to the gate voltage Vg of the driving transistor Tdr (that is, a unit that holds the gate voltage Vg). The second electrode E2 of the capacitive element C is connected to the voltage supply line 17. In such a manner, since the capacitive element C is interposed between the gate of the driving transistor Tdr and the voltage supply line 17, the gate voltage Vg changes due to a change of the voltage L[i] of the voltage supply line 17.

The p-channel transistor Tres shown in FIG. 10 is a switching element that is interposed between the gate of the driving transistor Tdr and the power line 181 so as to control an electrical connection between them. A gate of the transistor Tres is connected to the second control line 132. Therefore, if the second control signal Yb[i] is in the high level, the transistor Tres is turned off. Meanwhile, if the second control signal Yb[i] is in the low level, the transistor Tres is turned on, and the gate voltage Vg is initialized to the power-supply voltage Vdd.

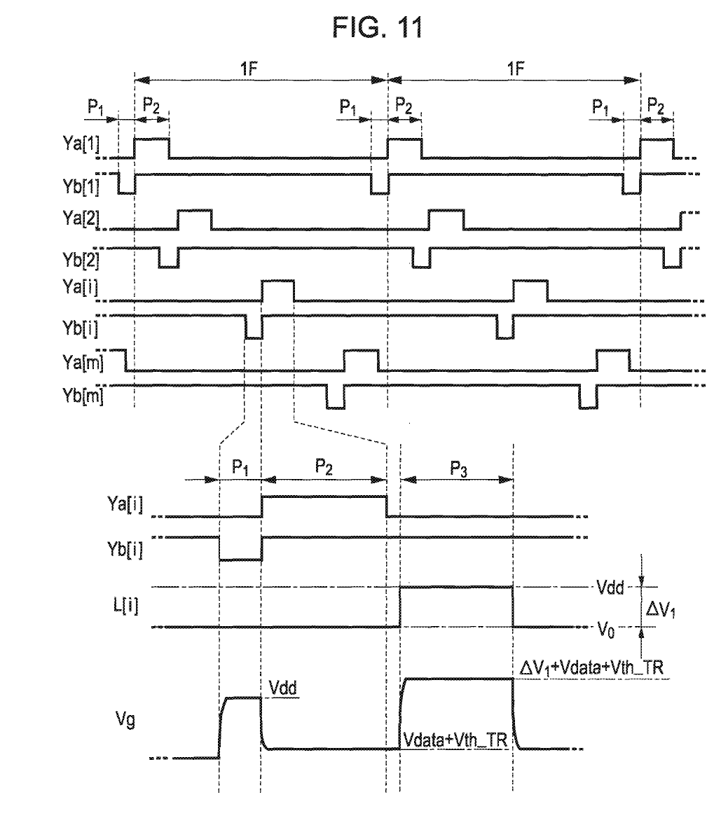

Next, specific waveforms of the individual signals to be used in the electronic device D wilt be described with reference to FIG. 11. As shown in FIG. 11, the first control signal Ya[1] to Ya[m] are signals that sequentially become the high level for each predetermined period (hereinafter, referred to as ‘writing period’) P2 in each frame (1F). That is the first control signal Ya[i] is kept at the high level in the first writing period P2 of one frame and is kept at the low level in other periods. The change of the first control signal Ya[i] to the high level means the selection of the i-th row. Meanwhile, as shown in FIG. 11, the second control signal Yb[i] becomes the low level in a period (hereinafter, referred to as ‘initialization period’) P1 before the start of the writing period P2 where the first control signal Ya[i] becomes the high level, and is kept at the high level in other periods.

Further, the voltage L[i] of the voltage supply line 17 of the i-th row is kept at the writing voltage V0 in the writing period P2 where the first control signal Ya[i] becomes the high level, and the initialization period P1 immediately before the writing period P2, and is kept at the power-supply voltage Vdd in a period (hereinafter, referred to as ‘driving period’) P3 after the writing period P2. More specifically, the voltage L[i] increases from the writing voltage V0 to the power-supply voltage Vdd at the start point of the driving period P3 after the end point of the writing period P2, and decreases to the writing voltage V0 again at the end point of the driving, period P3. Moreover, between the initialization period P1 and the writing period P2, between the writing period P2 and the driving period P3, or between the driving period P3 and the initialization period P1, an interval maybe arbitrarily provided. If a time interval is provided between the initialization period P1 and the writing period P2, in the initialization period P1, the gate voltage Vg of the driving transistor Tdr can be reliably initialized. Further, if a time interval is provided between the writing period P2 and the driving period P3, in the writing period P2, the gate voltage Vg can be reliably adjusted to a level according to the voltage Vdata.

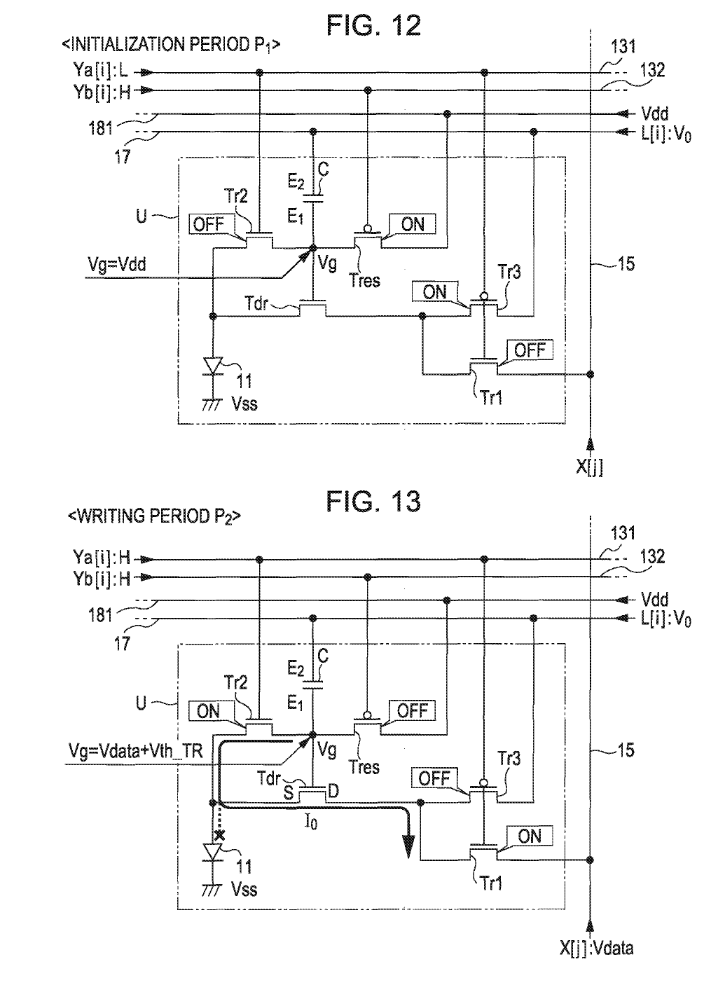

Next, the specific operation of the electronic device D will be described with reference to FIGS. 12 to 34. In the following description, the operation of the unit circuit U of the j-th column belonging to the i-th row will be described for each of the initialization period P1, the writing period P2, and the driving period P3 will be described.

(a) Initialization Period P1 (FIG. 12)

In the initialization period P1, the second control signal Yb[i] is changed to the low level, and thus, as shown in FIG. 12, the transistor Tres is turned on. Therefore, the gate of the driving transistor Tdr and the power line 181 are electrically connected to each other, and the gate voltage Vg is initialized to the power-supply voltage Vdd (that is, a voltage for allowing the driving transistor Tdr to be in the conduction state). Therefore, in the initialization period P1, the charges accumulated in the capacitive element C are initialized. In addition, in the initialization period P1, since the voltage L[i] of the voltage supply line 17 is set to the writing voltage V0, the second electrode E2 of the capacitive element C is set to the writing voltage V0. Moreover, in the initialization period P1, since the first control signal Ya[i] is kept at the high level the transistor Tr1 and the transistor Tr2 are turned off, and the transistor Tr3 is turned on. Meanwhile, since the voltage L[i] of the voltage supply line 17 is set to the writing voltage V0, the driving current Iel is not supplied to the electro-optical element 11.

Moreover, in this embodiment, the gate voltage Vg is initialized to the power-supply voltage Vdd in the initialization period P1, but a voltage for initialization is not limited to the power-supply voltage Vdd. For example, the gate voltage Vg may be initialized to a voltage equal to or more than the threshold voltage Vth_TR of the driving transistor Tdr. In addition, if a voltage to be applied to the gate of the driving transistor Tdr is set higher than the threshold voltage Vth_TR of the driving transistor Tdr and lower than the threshold voltage Vth_EL of the electro-optical element 11 in the initialization period P1, in the initialization period P1 or the writing period P2, the driving current Iel does not flow in the electro-optical element 11 at all (therefore, the electro-optical element 11 does not emit light at all).

(b) Writing Period P2 (FIG. 13)

After the initialization period P1 (the writing period P2 and the driving period P3), the second control signal Yb[i] is kept at the high level, and thus, as shown in FIG. 13, the transistor Tres is turned off. Meanwhile, in the writing period P2, the first control signal Ya[i] is changed to the high level. Therefore, the transistor Tr3 is turned off and the driving transistor Tdr and the voltage supply line 17 are electrically isolated from each other. Further, since the transistor Tr1 is turned on, the drain of the driving transistor Tdr and the data line 15 are electrically connected to each other, and the transistor Tr2 is turned on, such that the source and the gate of the driving transistor Tdr are electrically connected to each other (diode connection). That is, the gate of the driving transistor Tdr is connected to the data line 15 through the transistor Tr2, the source and the drain of the driving transistor Tdr, and the transistor Tr1.

Therefore, in the writing period P2, as shown in FIG. 11, the gate voltage Vg of the driving transistor Tdr decreases from the power-supply voltage Vdd set in the initialization period P1, and converges on the sum (Vg=Vdata+Vth_TR) of the voltage Vdata of the data signal X[j] and the threshold voltage Vth_TR of the driving transistor Tdr. The writing period P2 is set to have a time length enough to the convergence of the gate voltage Vg. In the writing period P2, since the transistor Tr2 is turned on, the voltage of the source of the driving transistor Tdr or the voltage of the anode of the electro-optical element 11 is equal to the gate voltage Vg(=Vdata−Vth_TR).

In this embodiment, the voltage Vdata of the data signal X[j] is selected such that the gate voltage Vg after the convergence in the writing period P2 (that is, the voltage of the source of the driving transistor Tdr or the anode of the electro-optical element 11) becomes a voltage that turns off the electro-optical element 11 (that is, stops driving). More specifically, as shown in FIG. 9, the range of the voltage Vdata is determined (Vdata+Vth_TR≦Vth_EL) such that the gate voltage Vg(=Vdata+Vth_TR) in the writing period P2 is equal to or less than the threshold voltage Vth_EL. That is, the sum of the maximum of the voltage Vdata (that is, a voltage Vdata corresponding to a maximum gray-scale level) and the threshold voltage Vth_TR of the driving transistor Tdr substantially becomes equal to the threshold voltage Vth_EL (an upper limit value). Meanwhile, the minimum of the voltage Vdata (that is, a voltage Vdata corresponding to a minimum gray-scale level) and the threshold voltage Vth_TR substantially becomes equal to the writing voltage V0 (a lower limit value).

As such, in the writing period P2, a forward voltage (the gate voltage Vg) to be applied to the electro-optical element 11 does not exceed the threshold voltage Vth_EL. Therefore, in the writing period P2, as indicated by an arrow in FIG. 13, a current I0 flows from the first electrode E1 of the capacitive element C and passes through the transistor Tr2, the source and the drain of the driving transistor Tdr, and the transistor Tr1 in that order. Meanwhile, as indicated by ‘x’ in FIG. 13, a current does not flow in the electro-optical element 11 after at least the anode of the electro-optical element 11 is equal to or less than the threshold voltage Vth_EL. As a result, in at least a part of the writing period P2, the light emission of the electro-optical element 11 stops.

(c) Driving Period P3 (FIG. 14)

If the writing period P2 passes, since the first control signal Ya[i] is changed to the low level, as shown in FIG. 14, the transistor Tr2 is turned off. Therefore, the diode connection of the driving transistor Tdr is released. At this time, since the transistor Tres is also turned on, in the driving period P3, the first electrode E1 of the capacitive element C (or the gate of the driving transistor Tdr) becomes a floating state. Further, with the first control signal Ya[i] of the low level, the transistor Tr1 is turned off, and the transistor Tr3 is turned on. Therefore, the connection destination of the drain of the driving transistor Tdr is switched from the data line 15 to the voltage supply line 17.

As shown in FIG. 11, at the start point of the driving period P3, the voltage control circuit 27 changes the voltage L[i] from the writing voltage V0 to the power-supply voltage Vdd. Now, since the first electrode E1 of the capacitive element C is in the floating state, as shown in FIGS. 9 and 11, the voltage (that is, the voltage L[i]) of the second electrode E2 connected to the voltage supply line 17 changes by ‘ΔV1(=Vdd−V0)’, the voltage (that is, the gate voltage Vg) of the first electrode E1 increases by ‘ΔV1’ by capacitive coupling of the capacitive element C. Therefore, as shown in FIG. 11, the gate voltage Vg in the driving period P3 converges on a voltage ‘ΔV1+Vdata+Vth_TR’ more than the power-supply voltage Vdd. As such, the conduction state of the driving transistor Tdr is set according to the voltage Vdata, and thus, as shown in FIG. 14, the driving current Iel corresponding to the voltage Vdata is supplied from the power line 181 to the electro-optical element 11 while passing through the transistor Tr3 and the driving transistor Tdr. Then, the electro-optical element 11 emits light at luminance according to the driving current Iel.

Now, if it is assumed that the driving transistor Tdr operates in a saturation region, the driving current Iel that is supplied to the electro-optical element 11 in the driving period P3 is represented by the following equation (1). Moreover, in the equation (1), ‘β’ is a gain coefficient of the driving transistor Tdr, and ‘Vgs’ is a gate between the gate and the source of the driving transistor Tdr.
Iel=(β/2) (Vgs−Vth_TR)² (1)

In the driving period P3, since the gate voltage Vg converges on ‘ΔV1+Vdata+Vth_TR’ on the basis of the ground voltage Vss, when the voltage of the source of the driving transistor Tdr (that is, an on voltage of the electro-optical element 11) in the driving period P3 is ‘Von’, the voltage Vgs becomes ‘ΔV1+Vdata+Vth_TR−Von’. If this value is substituted for Vgs, the equation (1) is modified to the following equation (2). Moreover, the voltage ‘Von’ is a voltage that id determined according to the characteristics of the electro-optical element 11.
Iel=(β/2)(ΔV1+Vdata−Von)² (2)

That is, the driving current Iel does not depend on the threshold voltage Vth_TR of the driving transistor Tdr. Therefore, according to this embodiment, a variation in threshold voltage Vth_TR in the individual unit circuits U is compensated, and thus the individual electro-optical elements 11 can emit light at predetermined luminance with high accuracy.

As described above, in this embodiment, the voltage of the source of the driving transistor Tdr (the gate voltage Vg) is set to a voltage less than the threshold voltage Vth_EL or the electro-optical element 11 in the writing period P2 where the anode of the electro-optical element 11 is electrically connected to the source and the gate of the driving transistor Tdr, and the gate voltage Vg is shifted by a predetermined value (ΔV1) in the driving period P3, such that the electro-optical element 11 is driven. Therefore, even though a switching element is not interposed between the driving transistor Tdr and the electro-optical element 11 so as to control the electrical connection between them, the distinguishment can be realized such that the light emission of the electro-optical element 11 can stop in the writing period P2, and the electro-optical element 11 can emit light in the driving period P3.

As the transistors constituting the unit circuit U (in particular, the driving transistor Tdr), for example, a so-called thin film transistor in which polycrystalline silicon, microcrystalline silicon, monocrystalline silicon, or amorphous silicon is used as a material for a semiconductor layer, or a transistor formed of bulk silicon can be used. The transistor actually used in the unit circuit U is appropriately selected according to the use or specification of a light-emitting device D.

Moreover, it is known, in transistors using amorphous silicon, if the direction of a current flowing therein is fixed constantly, the threshold voltage Vth_TR is shifted in a time-variant manner. According to this embodiment, the current I0 flowing in the driving transistor Tdr in the writing period P2 flows from the source to the drain, and the driving current Iel flowing in the driving transistor Tdr in the driving period P3 flows from the drain to the source. That is, the direction of the current flowing in the driving transistor Tdr is changed as the occasion demands. Then, according to this embodiment, even though the thin film transistor having a semiconductor formed of amorphous silicon are used as the driving transistor Tdr, the change of the threshold voltage Vth_TR can be suppressed.

### Third Embodiment

Next, an electronic device D according to a third embodiment of the invention will be described. Moreover, in this embodiment, the same parts as those in the second embodiment are represented by the same reference numerals, and the descriptions thereof will be omitted.

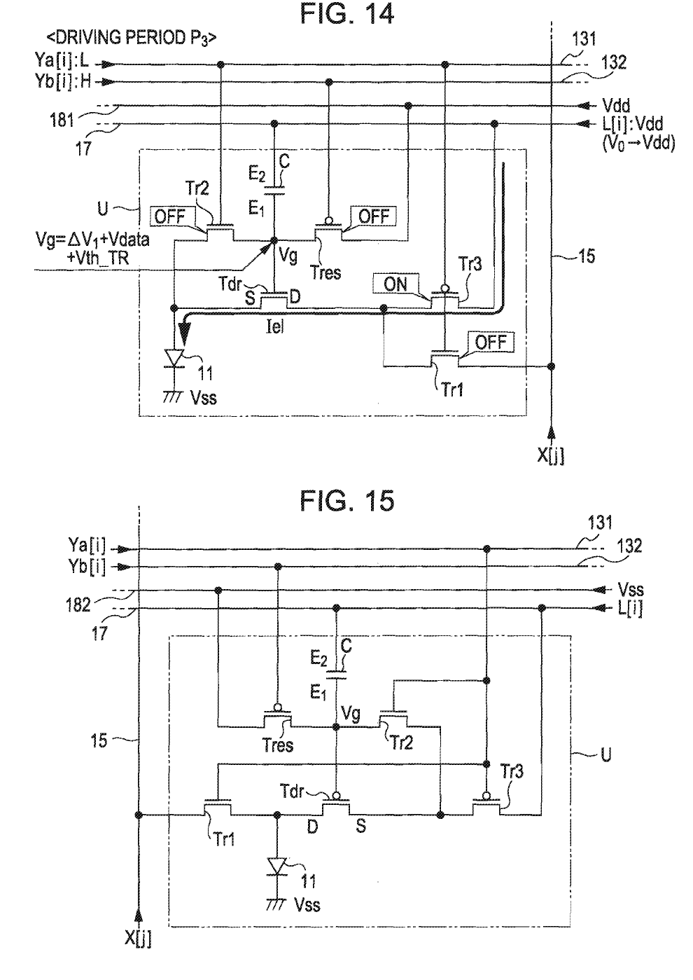

FIG. 15 is a circuit diagram showing the configuration of the unit circuit U according to this embodiment. As shown in FIG. 15, in this embodiment, the conductivity type of the driving transistor Tdr is a p-channel type. The electro-optical element 11 is connected to the drain (D) of the driving transistor Tdr. Moreover, like the second embodiment, each of the terminals of the driving transistor Tdr is switched from one of the source and the drain to the other, but, in this embodiment, for convenience of explanation, the terminal close to the electro-optical element 11 is represented by ‘drain’ and the opposing terminal is represented by ‘source’.

A transistor Tr1 that controls an electrical connection between the unit circuit U and the data line 15 is interposed between the drain of the driving transistor Tdr (that is, an anode of the electro-optical element 11) and the data line 15. Further, a transistor Tr2 that brings the driving transistor Tdr into diode connection is interposed between the source (S) and the gate of the driving transistor Tdr. In addition, a ground voltage Vss is supplied to the individual unit circuits U from the voltage control circuit 27 through a ground line 182. A transistor Tres is interposed between the ground line 182 and the gate of the driving transistor Tdr. Other parts are the same as those in the second embodiment.

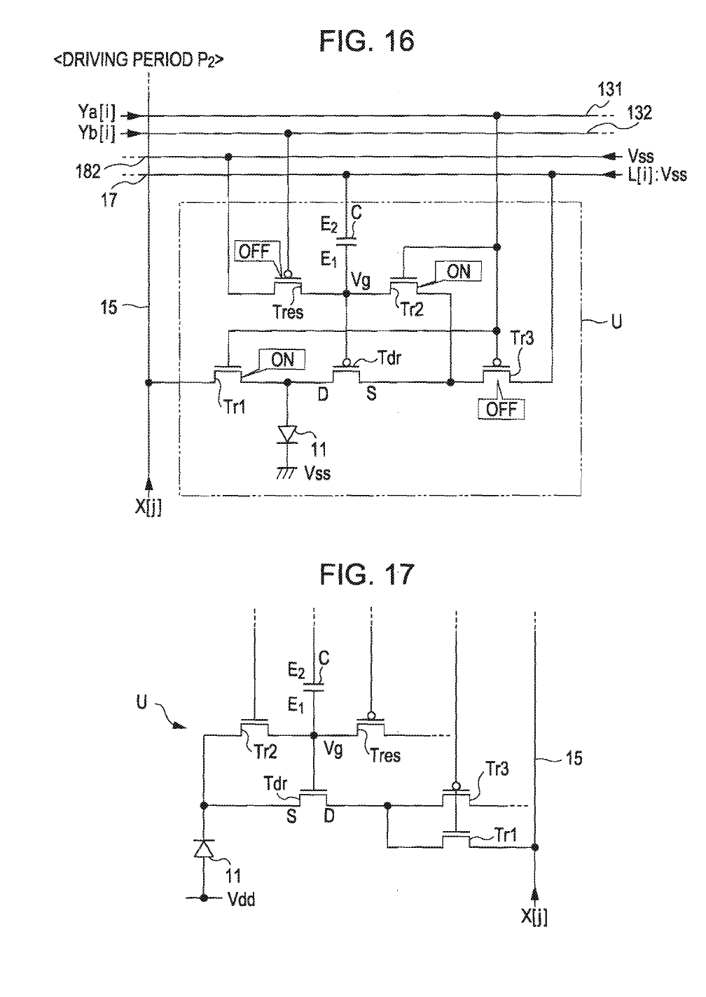

In this embodiment, like the second embodiment, the transistor Tres is turned on by the second control signal Tb[i] in the initialization period P1. Accordingly, the gate voltage Vg is initialized to the ground voltage Vss(that is, a voltage that allows the driving transistor Tdr to be in the conduction state). Next, in the writing period P2, as shown FIG. 16, since the voltage L[i] of the voltage supply line 17 is kept at the ground voltage Vss, the transistor Tres and the transistor Tr3 are turned off, and the transistor Tr1 and the transistor Tr2 are turned on. Therefore, the drain of the driving transistor Tdr and the data line 15 are electrically connected to each other through the transistor Tr1, and the source and the gate of the driving transistor Tdr are connected to each other (are brought into diode connection) through the transistor Tr2. Accordingly, the gate voltage Vg converges on ‘Vdata−Vth_TR’ in the writing period P2.

In the configuration of FIG. 15, since the anode of the electro-optical element 11 is connected between the driving transistor Tdr and the transistor Tr1, in the writing period P2, the voltage of the anode of the electro-optical element 11 (the voltage of the drain of the driving transistor Tdr) becomes the voltage Vdata of the data signal X[j]. Then, in this embodiment, the voltage Vdata of the data signal X[j] is selected (Vdata≦Vth_EL) so as not to exceed the threshold voltage Vth_EL of the electro-optical element 11, and thus the light emission of the electro-optical element 11 in the writing period P2 stops. More specifically, the voltage Vdata is selected to fall within a range from the writing voltage V0 to the threshold voltage Vth_EL (V0≦Vdata≦Vth_EL).

Meanwhile, at the start point of the driving period P3, the voltage L[i] of the voltage supply line 17 increases from the ground voltage Vss to the power-supply voltage Vdd by ‘ΔV2’. Due to the increase of the voltage L[i], the gate voltage Vg converges on ‘ΔV2+Vdata−Vth_TR’. Further, in the driving period P3, since the voltage supply line 17, to which the voltage Vdd is supplied, and the source of the driving transistor Tdr are electrically connected to each other through the transistor Tr3, the driving current Iel according to the gate voltage Vg passes through the voltage supply line 17 and the driving transistor Tdr to be then supplied to the electro-optical element 11. As such, in this embodiment, since the driving current Iel is determined according to the threshold voltage Vth_TR of the driving transistor Tdr, a difference in luminance of the electro-optical element 11 due to a variation in threshold voltage Vth_TR of the individual driving transistors Tdr is suppressed.

As described above, in this embodiment, the voltage Vdata is set so as not to exceed the threshold voltage Vth_EL of the electro-optical element 11. Therefore, like the second embodiment, even though a switching element is not interposed between the driving transistor Tdr and the electro-optical element 11, in the writing period P2, the light emission of the electro-optical element can reliably stop. Further, in this embodiment, since the driving transistor Tdr is the p-channel type, as compared with the configuration of the second embodiment in which the n-channel driving transistor Tdr is used, the range of the change of the gate voltage Vg can be suppressed (ΔV2<ΔV1).

Moreover, if the driving current Iel starts to be supplied to the electro-optical element 11, the voltage V[i] of the voltage supply line 17 drops. However, like this embodiment, in the configuration in which the driving transistor Tdr is the p-channel type, the gate voltage Vg of the driving transistor Tdr also drops by the drop amount of the voltage L[i] due to capacitive coupling of the capacitive element C. That is, a correction for increasing the conduction state of the driving transistor Tdr (that is, a correction for increasing the driving current Iel corresponding to the drop of the voltage L[i]) can be automatically performed.

Modifications

As regards the above-described embodiment, various modifications can be made. Specific modifications are as follows. Moreover, the modifications can be appropriately combined.

(1) First Modification

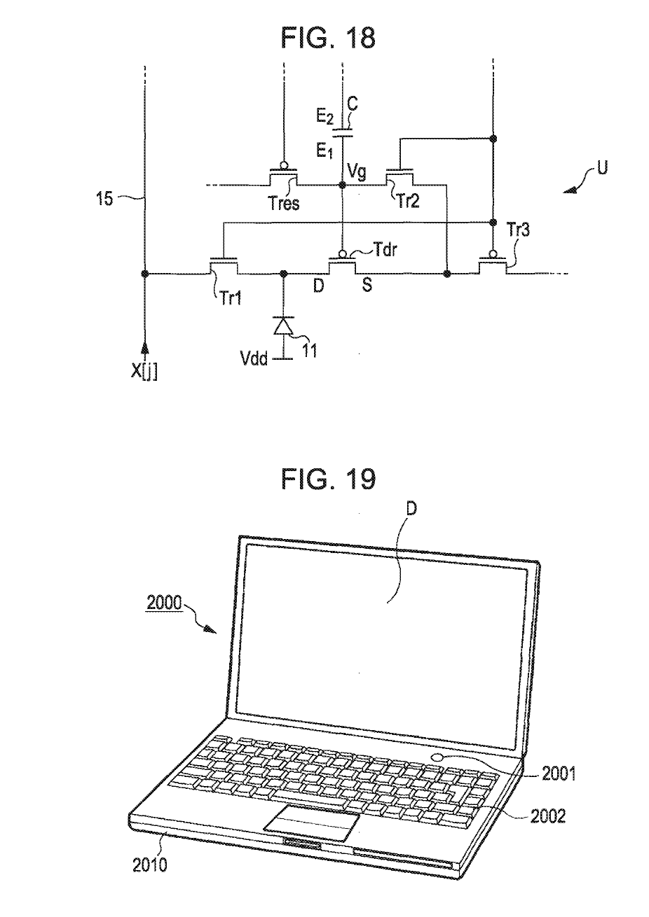

In the above-described second or third embodiment, the anode of the electro-optical element 11 is connected to the driving transistor Tdr. In this configuration, as described in the second or third embodiment, in the writing period P2, the Vdata is selected such that the voltage of the anode of the electro-optical element 11 (Vdata+Vth_TR in the second embodiment or Vdata in the third embodiment) is less than the threshold voltage Vth_EL, and thus driving of the electro-optical element 11 stops. In the driving period P3, the voltage L[i] of the voltage supply line 17 increases, and thus the electro-optical element 11 is driven. In contrast, as shown in FIG. 17 or 18, the cathode of the electro-optical element 11 may be connected to the driving transistor Tdr, and the anode of the electro-optical element 11 may be kept at the power-supply voltage Vdd. FIG. 17 shows a modification of the unit circuit U of the second embodiment, and FIG. 18 shows a modification of the unit circuit U of the third embodiment.

According to this configuration, in the writing period P2, the voltage of the cathode of the electro-optical element 11 is kept at a voltage more than a difference ‘Vdd−Vth_EL’ between the power-supply voltage Vdd and the threshold voltage Vth_EL (that is, a voltage that stops driving of the electro-optical element 11). For example, in the configuration of FIG. 17, like the second embodiment, since the voltage of the source of the driving transistor Tdr (that is, the voltage of the cathode of the electro-optical element 11) becomes ‘Vdata+Vth_TR’ in the writing period P2, the range of the voltage Vdata of the data signal X[j] is selected such that the voltage ‘Vdata+Vth_TR’ is equal to or moire than ‘Vdd−Vth_EL).’ (Vdd−Vth_EL≦Vdata+Vth_TR). Meanwhile, in the configuration of FIG. 18, like the third embodiment, since the voltage of the drain of the driving transistor Tdr becomes Vdata in the writing period P2, the range of the voltage Vdata is determined such that the condition Vdd−Vth_EL≦Vdata is satisfied.

Further, in the configuration of FIG. 17 or FIG. 18, after the writing period P2 (at the start point of the driving period P3), the voltage control circuit 27 decreases the voltage L[i] of the voltage supply line 17. With the decrease, the voltage of the cathode of the electro-optical element 11 is set to a voltage less than ‘Vdd−Vth_EL]’, such that the electro-optical element 11 emits light in the driving period P3. As described above, in this modifications, the same advantages as those in the above-described embodiments can be obtained.

(2) Second Modification

The specific configuration of the unit circuit U is not limited to the above illustrations. For example, the conductivity types of the transistors can be appropriately changed. Further, in the above-described embodiment, the transistor Tres that initializes the gate voltage Vg before the writing period P2 is provided, but the transistor Tres may be omitted. In addition, in the above-described embodiment, the transistor Tr1, the transistor Tr2, and the transistor Tr3 are controlled by the common, signal (the first control signal Ya[i]), but the transistors may be controlled by separate signals. Therefore, the transistor Tr3 may have the same conductivity type as the transistor Tr1 or the transistor Tr2.

(3) Third Modification

In the above-described embodiment, the range of the voltage Vdata is selected such that the electro-optical element 11 is completely turned off in the writing period P2. However, in the invention, the electro-optical element 11 is not necessarily completely turned off. For example, in the second embodiment, the range of the voltage Vdata is selected such that the condition ‘Vdata+Vth_TR≦Vth_EL’ is satisfied, and thus the supply of the current to the electro-optical element 11 completely stops in the writing period P2. However, as long as luminance of the electro-optical element 11 does not cause a problem in a practical use as a display device (that is, an observer does not view at all) in the writing period P2, the voltage ‘Vdata+Vth_TR’ (Vdata in the third embodiment) of the anode of the electro-optical element 11 in the writing period P2 may be more than the threshold voltage Vth_EL. Similarly, in the configuration of FIG. 17, the voltage ‘Vdata+Vth_TR’ (the voltage Vdata in the configuration of FIG. 18) of the cathode of the electro-optical element 11 may he less than ‘Vdd−Vth_EL’ in the writing period P2. That is, in the invention, what is necessary is that the voltage to be applied to the electro-optical element 11 in the writing period P2 and the voltage to be applied to the electro-optical element 11 after the writing period P2 can be different due to the change in voltage of the voltage supply line 17.

(4) Fourth Modification

In the above-described embodiment, the OLED element is illustrated as the electro-optical element 11, but an electro-optical element that is used in the electronic device of the invention is not limited to the OLED element. For example, instead of the OLED element various self-luminescent elements, such as inorganic EL elements, field emission (FE) elements, SE (Surface-conduction Electron-emitter) elements, BS (Ballistic electron Surface emitting) elements, or LED (Light Emitting Diode) elements, or various electro-optical elements, such as electrophoretic elements or electrochromic elements, can be used. Further, the invention is applied to a sensing device, such as a biochip or the like. The driven element of the invention includes all parts that are driven by electric energy. The electro-optical elements, such as light-emitting elements or the like, are just for illustrative.

Applications

Electronic apparatuses that use the electronic device according to the embodiment of the invention will be described. FIG. 19 is a perspective view showing the configuration of a mobile personal computer that uses the electronic device D according to any one of the above-described embodiments as a display device. The personal computer 2000 includes the electronic device D serving as a display device, and a main body portion 2010. In the main body portion 2010, a power switch 2001 and a keyboard 2002 are provided. Since the electronic device D uses the OLED element as the electro-optical element 11, an easily viewable screen having a wide viewing angle can be displayed.

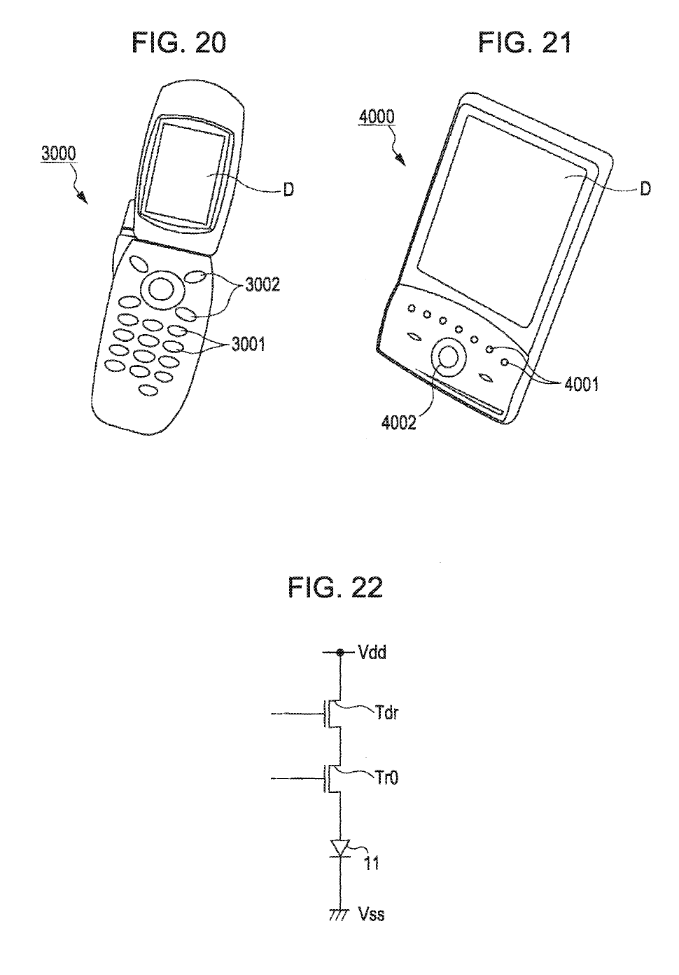

FIG. 20 shows the configuration of a cellular phone to which the electronic device D according to each of the embodiments is applied. The cellular phone 3000 includes a plurality of operating buttons 3001 and scroll buttons 3002, and the electronic device D as a display device. If the scroll buttons 3002 operate, a screen displayed on the electronic device D is scrolled.

FIG. 21 shows the configuration of a personal digital assistant (PDA) to which the electronic device D according to each of the embodiments is applied. The personal digital assistant 4000 includes a plurality of operating buttons 4001, a power switch 4002, and the electronic device D as a display device. If the power switch 4002 operates, various kinds of information, such as an address book or a scheduler, are displayed on the electronic device D.

Moreover, as the electronic apparatus to which the electronic device according to the embodiment of the invention is applied, in addition to those shown in FIGS. 19 to 21, a digital still camera, a television, a video camera, a car navigation device, a paver, an electronic organizer, an electronic paper, an electronic calculator, a word processor, a workstation, a video phone, a POS terminal, a printer, a scanner, a copy machine, a video player, an apparatus having a touch panel and so on can be exemplified. Further, the use of the electronic device according to the embodiment of the invention is not limited to image display. For example, in an image forming apparatus, such as an optically writable printer or an electronic copy machine, a writing head that exposes a photosensitive member according to an image to be formed on a recording medium, such as a paper or the like, is used. The electronic device of the invention is used as such a writing head. The unit circuit used in the invention includes a circuit that is a unit of exposure in an image forming apparatus, in addition to the circuit (a so-called pixel circuit) constituting a pixel of a display device, like the above-described embodiments.

What is claimed is:

1. A method of driving an electronic device having a unit circuit having a driven element, and having a driving transistor, the driving transistor having a control terminal, a first terminal, and a second terminal, a conduction state between the first terminal and the second terminal changing according to a potential of the control terminal, the unit circuit having the driven element to be driven according to the conduction state of the driving transistor, the method comprising:
supplying a first potential to a potential supply line in an initialization period, and electrically connecting the potential supply line and the control terminal of the driving transistor to each other;
electrically connecting a data line to which a data signal is supplied, and the first terminal of the driving transistor to each other in a writing period after the initialization period; and
supplying a second potential different from the first potential to the potential supply line in a driving period after the writing period, and electrically connecting the potential supply line and the second terminal of the driving transistor in the driving period so as to drive the driven element.

2. An electronic device, comprising:
a plurality of first wiring lines;
a plurality of second wiring lines that intersect the plurality of first wiring lines;
a plurality of potential supply lines;
a plurality of unit circuits that are correspondingly disposed at intersections of the plurality of first wiring lines and the plurality of second wiring lines;
a selection circuit that selects each of the plurality of first wiring lines;
a data supply circuit that supplies a data signal to the plurality of second wiring lines in each writing period; and
a voltage control circuit that sets each the plurality of potential supply lines to have a plurality of potentials,
each of the plurality of unit circuits having:
a driving transistor that has a control terminal, a first terminal, and a second terminal, a conduction state between the first terminal and the second terminal that changes according to a potential of the control terminal,
a driven element that is driven according to the conduction state of the driving transistor,
a first switching element that electrically connects the first terminal of the driving transistor and the second wiring lines in the writing period, where one first wiring line among the plurality of first wiring lines is selected, and
a potential setting unit that electrically connects one potential supply line among the plurality of potential supply lines and the control terminal of the driving transistor to each other in an initialization period before the start of the writing period, and electrically connects one potential supply line and the second terminal of the driving transistor to each other in a driving period after the writing period.

3. The electronic device according to claim 2,
the voltage control circuit setting the potential of one potential supply line to a first potential in the initialization period, and setting the potential of one potential supply line to a second potential different from the first potential in the driving period after the writing period.

4. The electronic device according to claim 2,
each of the plurality of unit circuits having a capacitive element that has a first electrode connected to the control terminal of the driving transistor and a second electrode to be kept at a constant potential in at least the driving period.

5. The electronic device according to claim 4,
the second electrode of the capacitive element being connected to a first wiring line different from one first wiring line among the plurality of first wiring lines.

6. The electronic device according to claim 5,
the second electrode of the capacitive element being connected to a different first wiring line that is selected immediately before one first wiring line among the plurality of first wiring lines.

7. The electronic device according to claim 2,
the potential setting unit having a second switching element electrically connecting one potential supply line and the second terminal of the driving transistor to each other in the initialization period and the driving period, and electrically isolating one potential supply line and the second terminal of the driving transistor from each other in the writing period.

8. The electronic device according to claim 7,
the potential setting unit having a third switching element electrically connecting the second terminal and the control terminal of the driving transistor to each other in the initialization period and the writing period, and electrically isolating the second terminal and the control terminal of the driving transistor from each other in the driving period.

9. The electronic device according to claim 25
each of the plurality of unit circuits having a fourth switching element that controls an electrical connection between the first terminal of the driving transistor and the driven element.

10. The electronic device according to claim 9,
the first switching element and the fourth switching element being two transistors of different conductivity types, and gates of the two transistors being commonly connected to one first wiring line.

11. The electronic device according to claim 3,
the first potential being a potential for turning on the driving transistor.

12. The electronic device according to claim 2,
the plurality of potential supply lines intersecting the plurality of second wiring lines.

13. An electronic apparatus, comprising:
the electronic device according to claim 2.

14. An electro-optical device comprising:
a plurality of scanning lines;
a plurality of data lines that intersect the plurality of scanning lines;
a plurality of potential supply lines;
a plurality of unit circuits that are correspondingly arranged at intersections of the plurality of scanning lines and the plurality of data lines;
a scanning line driving circuit that selects each of the plurality of scanning lines;
a data line driving circuit that supplies data signals to the plurality of data lines in each writing period; and
voltage control circuit that sets each of the plurality of potential supply line to have a plurality of potentials.
each of the plurality of unit circuits having:
a driving transistor that has a control terminal, a first terminal, and a second, a conduction state between the first terminal and the second terminal changing according to a potential of the control terminal.
an electro-optical element that is driven according to the conduction state of the driving transistor,
a first switching element that electrically connects the first terminal of the driving transistor and the data lines to each other in a writing period where one scanning line among the plurality of scanning lines is selected, and
a potential setting unit that electrically connects one potential supply line among the plurality of potential supply line and the control terminal of the driving transistor to each other in an initialization period before the start of the writing period, and electrically isolates one potential supply line and the second terminal of the driving transistor from each other in the driving period after the writing period.

15. A method of driving an electronic device, having a unit circuit having a driven element, and having a driving transistor, the driving transistor having a control terminal, a first terminal, and a second terminal, a conduction state between the first terminal and the second terminal changing according to a voltage of the control terminal, the unit circuit having the driven element to be driven according to the conduction state of the driving transistor, the method comprising:
supplying a data voltage to a signal line, and electrically connecting one of the voltage to the control terminal through the other terminal of the first terminal and the second terminal in a writing period; and
changing the voltage of the control terminal by a predetermined amount so as to set the conduction state of the driving, transistor after the writing period.

16. The method of driving an electronic device according to claim 15,
the unit circuit having a capacitive element that has a first electrode connected to the control terminal and a second electrode connected to a voltage supply line,
in at least a part of the writing period, a voltage of the voltage supply line being set to a first voltage level, and
after the writing period the voltage of the voltage supply line being changed to a second voltage level different from the first voltage level so as to cause the voltage of the control terminal to be changed.

17. An electronic device, comprising:
a signal line;
a voltage supply line;
a data supply circuit that supplies a data voltage to the signal line in a writing period;
a voltage control circuit that sets a voltage of the voltage supply line to a first voltage level in at least a part of the writing period, and changes the voltage of the voltage supply line to a second voltage level different from the first voltage level after the writing period; and
a unit circuit,
the unit circuit having:
a driving transistor that has a control terminal, a first terminal, and a second terminal, a conduction state between the first terminal and the second terminal changing according to a voltage of the control terminal,
a driven element that is driven according to the conduction state of the driving transistor.
a voltage setting unit that electrically connects one of the first terminal and the second terminal and the signal line to each other in at least a part of the writing period so as to supply a data voltage to the control terminal through the other terminal of the first terminal and the second terminal, and
a capacitive element that has a first electrode connected to the control terminal and a second electrode connected to the voltage supply line.

18. The electronic device according to claim 17,
a switching element being interposed between the driving transistor and the driven element.

19. The electronic device according to claim 17,
the first electrode being in a floating state after the writing period.

20. The electronic device according to claim 17,
the driven element being driven when a voltage level of the first terminal is more than a predetermined voltage level, and
the second voltage level being higher than the first voltage level.

21. The electronic device according to claim 20,
the driven element being driven when the voltage level of the first terminal is more than a threshold voltage of the driven element,
the voltage setting unit having a first switching element that electrically connects the second terminal and the signal line to each other in at least a part of the writing period, and
the sum of the data voltage and a threshold voltage of the driving transistor being less than the threshold voltage of the driven element.

22. The electronic device according to claim 20,
the driven element being driven when the voltage of the first terminal is more than a threshold voltage of the driven element,
the voltage setting unit having a first switching element that electrically connects the first terminal and the signal line to each other in at least a part of the writing period, and
the data voltage being less than the threshold voltage of the driven element.

23. The electronic device according to claim 17,
the voltage setting unit having a first switching element that controls an electrical connection between one of the first terminal and the second terminal and the signal line, a second switching element that controls an electrical connection between the other terminal of the first terminal and the second terminal and the control terminal, and
the first switching, element and the second switching element being controlled by a signal to be supplied to a single wiring line.

24. The electronic device according to claim 23,
the driven element being connected to the first terminal of the driving transistor,
the voltage setting unit having a third switching element that electrically connects a feed line, whose voltage is set to a predetermined voltage level, and the second terminal after the writing period, and
the first switching element, the second switching element, and the third switching element being controlled by a signal to be supplied to a single wiring line.

25. The electronic device according to claim 17,
the unit circuit having a reset unit that sets the voltage of the control terminal to a predetermined voltage level before the writing period.

26. The electronic device according to claim 17,
the driven element being driven when the voltage level of the first terminal is less than a predetermined voltage level, and
the second voltage being lower than the first voltage.

27. The electronic device according to claim 17,
the voltage supply line intersecting the signal line.

28. An electronic apparatus, comprising:
the electronic device according to claim 17.

29. An electro-optical device, comprising:
data lines;
voltage supply lines;
a data line driving circuit that supplies a data voltage to each of the data lines in a writing period;
a voltage control circuit that sets a voltage of each of the voltage supply line to a first voltage level in at least a part of the writing period, and changes the voltage of the voltage supply line to a second voltage level different from the first voltage level after the writing period; and
unit circuits.
each of the unit circuits having:
a driving transistor that has a control terminal, a first terminal, and a second terminal, a conduction state between the first terminal and the second terminal changing according to a voltage of the control terminal,
an electro-optical element that is driven according to the conduction state of the driving transistor,
a voltage setting unit that electrically connects one of the first terminal and the second terminal and the data line in at least a part of the writing period so as to supply the data voltage to the control terminal through the other terminal of the first terminal and the second terminal, and
a capacitive element that has a first electrode connected to the control terminal and a second electrode connected to the voltage supply line.

30. A driving circuit, comprising:
a data wiring line;
a voltage source wiring line;
a plurality of control lines,
a plurality of control transistors, each controlled to one of open and close, based upon signals applied to the plurality of control lines;
a driven element; and
a driving transistor that:
conducts a first current in a first direction driven by a first voltage on the voltage source wiring line in response to first set of control signals applied to the plurality of control lines during a first time period,
conducts a second current in a second direction, opposite the first direction, driven by a voltage on the data wiring line in response to second set of control signals applied to the plurality of control lines during a second time period, and
conducts a third current in the first direction driven by a second voltage on the voltage source wiring line in response to a third set of control signals applied to the plurality of control lines during a third time period, the third current driving the driven element.

31. A method for controlling a driving circuit, that includes a data wiring line, a voltage source wiring line, a plurality of control lines, a plurality of Control transistors, a driven element, and a driving transistor, the method comprising:
controlling each of the control transistors to one of open and close, based upon signals applied to the plurality of control lines, so that the driving transistor:
conducts a first current in a first direction driven by a first voltage on the voltage source wiring line in response to first set of signals applied to the plurality of control lines during a first time period,
conducts a second current in a second direction, opposite the first direction, driven by a voltage on the data wiring line in response to second set of signals applied to the plurality of control lines during a second time period, and
conducts a third current in the first direction driven by a second voltage on the voltage source wiring line in response to a third set of signals applied to the plurality of control lines during a third time period, the third current driving the driven element.
